(19) United States
(12) Patent Application Publication
(10) Pub. No.: US 2026/0088002 A1
(43) Pub. Date: Mar. 26, 2026

(54) DRIVER SYSTEM OF ACTIVE MATRIX CHOLESTERIC LIQUID CRYSTAL DISPLAY AND DYNAMIC IMAGE DISPLAYING METHOD THEREOF

(71) Applicant: GENETOUCH CORP., Taoyuan City (TW)

(72) Inventors: Cheng-Yu CHEN, Taoyuan City (TW); Chi LEE, Taoyuan City (TW)

(73) Assignee: GENETOUCH CORP., Taoyuan City (TW)

(21) Appl. No.: 19/331,884

(22) Filed: Sep. 17, 2025

(30) Foreign Application Priority Data
Sep. 23, 2024 (TW) 113135969

(51) Int. Cl. G09G 3/36; G02F 1/133; G09G 3/20

(52) U.S. Cl. CPC G09G 3/3651; G09G 3/2096; G09G 3/3607; G09G 3/3614; G02F 1/13306; G09G 2300/0486; G09G 2310/061; G09G 2310/08; G09G 2320/0233; G09G 2320/0257; G09G 2320/041; G09G 2340/0435

(57) ABSTRACT

A dynamic image displaying method of an active matrix cholesteric liquid crystal display (AM ChLCD) is executed by a driver system for controlling the AM ChLCD. The method includes: generating a voltage control command, a gate control command, and an image display command according to a dynamic image parameter data, a data enable signal, and a vertical synchronization signal; generating a gate driver voltage and a plurality of data driver voltages according to the voltage control command; executing a set of image display sequences for: outputting the gate driver voltage for switching on or switching off a plurality of display units of the AM ChLCD, controlling a chronological sequence of switching on or switching off the plurality of display units according to the gate control command, and outputting the plurality of data driver voltages to the plurality of display units that are switched on, thus displaying a dynamic image.

### CROSS-REFERENCE TO RELATED APPLICATION(S)

This application claims the priority benefit of TW application serial No. 113135969 filed on Sep. 23, 2024, the entirety of which is hereby incorporated by reference herein and made a part of the specification.

### BACKGROUND OF THE INVENTION

### 1. Field of the Invention

The present invention relates to a driver system of a cholesteric liquid crystal display and a displaying method thereof, more particularly a driver system of an active matrix cholesteric liquid crystal display and a dynamic image displaying method thereof.

### 2. Description of the Related Art

A cholesteric liquid crystal display (ChLCD) is known to exhibit bistable liquid crystal displaying properties, meaning that the ChLCD is able to remain stable in two different states—a planar (texture) state and a focal conic (texture) state. In the planar state, the cholesteric liquid crystal is able to reflect incident light of particular wavelengths, and thus, the planar texture stable state may also be called a reflective state or a bright state. In the focal conic state, the cholesteric liquid crystal is able to scatter incident light, allowing the scattered incident light to pass through and be absorbed by a black film installed in the back of the ChLCD. For this reason, the focal conic state of the cholesteric liquid crystal may also be called a scattered state or a dark state.

When applying a driving voltage across the cholesteric liquid crystal, cholesteric liquid crystal molecules would be affected by an applied electric field, thus twisting and changing their arrangements, and allowing the cholesteric liquid crystal to change its state into either the planar state or the focal conic state. By applying various driving voltages across a plurality of cholesteric liquid crystals, the plurality of cholesteric liquid crystals may be arranged to be in the planar state or the focal conic state for a certain ratio, and thus a reflectance of the cholesteric liquid crystals may be tuned, allowing the cholesteric liquid crystals to display different grey scales and colors. According to the bistable properties, when the cholesteric liquid crystal is no longer supplied with the driving voltage, the cholesteric liquid crystal would stably maintain its current state. In other words, only when the cholesteric liquid crystal is supplied with the driving voltage would the cholesteric liquid crystal change its molecule arrangements for altering an image that is being displayed. Since the ChLCD is able to maintain the image that is currently being displayed when the ChLCD is not supplied with the driving voltage, the ChLCD is more often used for displaying a static image than other types of displaying devices.

A conventional passive matrix cholesteric liquid crystal display (PM ChLCD) includes a display panel, a scan driver, a data driver, a plurality of scan lines, and a plurality of data lines. The display panel includes a plurality of display units. The scan driver is connected to the plurality of scan lines, and each of the scan lines is mounted along a horizontal direction and is connected with each of the display units along a same horizontal line. The data driver is connected to the plurality of data lines, and each of the data lines is mounted along a vertical direction and is connected with each of the display units along a same vertical line. As a result, each of the display units is connected to one of the scan lines along the horizontal direction and is connected to one of the data lines along the vertical direction.

When the PM ChLCD displays an image, the scan driver drives each of the scan lines in a set order, and the data driver correspondingly inputs a data signal into each of the display units according to the set order of how each of the scan lines is chronologically driven. Since the PM ChLCD is required to drive each of the scan lines in the set order, and since the PM ChLCD uses passive electronic components, the PM ChLCD requires a lot of time for driving each of the display units to update an overall displaying screen. When the PM ChLCD is utilized to display a dynamic image, an update time required for updating the dynamic image between different frames is too long, and thus the dynamic image may appear to be lagging between frames, hence negatively affecting a user's viewing experience of the dynamic image.

Furthermore, by using passive electronic components, the PM ChLCD tends to have a lower contrast for a displaying image, and the PM ChLCD also requires more time for the data driver to output the data signals respectively into each of the display units, or requires the data driver to output the data signals respectively into each of the display units with more iterations, in order to ensure the cholesteric liquid crystal would have enough time to properly enter the focal conic state. Therefore, to ensure the dark state is sufficiently dark to satisfy an expected degree of contrast, a large amount of time is required for updating a current display, hence the PM ChLCD can hardly be utilized for displaying dynamic images.

On the other hand, the PM ChLCD is controlled by a timing controller. The timing controller not only stores an image data, but also processes the image data for generating a timing signal and a data signal correspondingly. Apart from using the timing signal and the data signal to control the scan driver and the data driver, the timing controller also stores the timing signal and the data signal, thus allowing the timing controller to iteratively output the data signal to each of the display units through the data driver for brightening a brightness of the current display. As such, the timing controller requires implementing a large internal memory or connecting to a large external memory for storing a large amount of data. Either way, requiring a large memory amounts to high cost for implementing the timing controller, and renders the timing controller relatively bulky in physical size. As the timing controller is unable to be further minimized in physical size, a driver of the ChLCD is also unable to be further minimized in physical size.

Furthermore, when consecutively supplying voltage of a same polarity to the ChLCD, the cholesteric liquid crystal molecules tend to be permanently polarized, thus creating voltage bias among the cholesteric liquid crystal molecules. This phenomenon hinders the ability for the cholesteric liquid crystal molecules to twist to expected angles, and therefore, causes the ChLCD to display abnormally with image sticking and uneven brightness, and causes the ChLCD to have a short life expectancy.

Overall, as the conventional PM ChLCD is driven to display images with low and limited refresh rates, the images cannot be efficiently displayed and swiftly updated by the conventional PM ChLCD, which negatively affects a viewing experience of a user towards the conventional PM ChLCD. For this reason, the conventional PM ChLCD can hardly be utilized to display dynamic images. Moreover, as the conventional PM ChLCD tends to have its cholesteric liquid crystal molecules permanently polarized, as the conventional PM ChLCD tends to have a relatively short life expectancy, and as the conventional PM ChLCD requires high implementation cost for implementing the timing controller with large memory, the conventional PM ChLCD leaves much improvement to be desired.

### SUMMARY OF THE INVENTION

To overcome the aforementioned shortcomings, the present invention provides a driver system of an active matrix cholesteric liquid crystal display (AM ChLCD) and a dynamic image displaying method thereof. The present invention is able to increase a refresh rate of the AM ChLCD, thus allowing the AM ChLCD to be utilized for displaying a dynamic image. The present invention also prevents polarizations of cholesteric liquid crystal molecules by driving the AM ChLCD with opposite polarity driving voltages. As such, the present invention is also able to extend a life expectancy of the AM ChLCD.

The present invention provides the driver system of the AM ChLCD that is utilized for controlling the AM ChLCD. The AM ChLCD includes a gate driver component, a data driver component, and a plurality of display units. The plurality of display units are electrically connected to the gate driver component and the data driver component. The driver system of the AM ChLCD includes:
a timing controller, connected to the AM ChLCD; wherein according to a dynamic image parameter data, a data enable signal, and a vertical synchronization signal, the timing controller generates a voltage control command, a gate control command, and an image display command, outputs the gate control command to the gate driver component, outputs the image display command to the data driver component, and controls the AM ChLCD to execute a set of image display sequences; wherein the dynamic image parameter data corresponds to a dynamic image that consists of a plurality of images, and each of the image display sequences within the set of image display sequences is executed to display one of the images of the dynamic image;
a power supply module, connected to the timing controller and the AM ChLCD; wherein according to the voltage control command, the power supply module generates a gate driver voltage and a plurality of data driver voltages, outputs the gate driver voltage to the gate driver component, and outputs the plurality of data driver voltages to the data driver component;
wherein in the set of image display sequences: the timing controller controls a chronological sequence of commanding the gate driver component to switch on or switch off the plurality of display units according to the gate control command; the gate driver component controls the plurality of display units to switch on or switch off according to the gate driver voltage; according to the image display command, the timing controller controls the data driver component to output the plurality of data driver voltages to the plurality of display units that are switched on;
wherein within any two consecutive image display sequences within the set of image display sequences, an averaged voltage magnitude of the plurality of data driver voltages outputted by the data driver component within one of the two consecutive image display sequences equals an averaged voltage magnitude of the plurality of data driver voltages outputted by the data driver component within the other one of the two consecutive image display sequences;
wherein within any two consecutive image display sequences within the set of image display sequences, an overall averaged voltage magnitude of the plurality of data driver voltages outputted by the data driver component is zero.

The present invention also provides a dynamic image displaying method of the AM ChLCD that is utilized for controlling the AM ChLCD. The dynamic image displaying method includes the following steps:
generating a voltage control command, a gate control command, and an image display command according to a dynamic image parameter data, a data enable signal, and a vertical synchronization signal; wherein the dynamic image parameter data corresponds to a dynamic image that consists of a plurality of images;
generating a gate driver voltage and a plurality of data driver voltages according to the voltage control command;
executing a set of image display sequences; wherein each of the image display sequences within the set of image display sequences includes steps of: outputting the gate driver voltage for switching on or switching off a plurality of display units of the AM ChLCD, controlling a chronological sequence of switching on or switching off the plurality of display units according to the gate control command, and outputting the plurality of data driver voltages to the plurality of display units that are switched on; wherein each of the image display sequences within the set of image display sequences controls the AM ChLCD to display one of the images of the dynamic image;
wherein within any two consecutive image display sequences within the set of image display sequences, an averaged voltage magnitude of the plurality of data driver voltages outputted by a data driver component within one of the two consecutive image display sequences equals an averaged voltage magnitude of the plurality of data driver voltages outputted by the data driver component within the other one of the two consecutive image display sequences;
wherein within any two consecutive image display sequences within the set of image display sequences, an overall averaged voltage magnitude of the plurality of data driver voltages outputted by the data driver component is zero.

In the present invention, the timing controller controls the AM ChLCD with the gate control command and the image display command, thus allowing the AM ChLCD to display a dynamic image, and according to the voltage control command, the power supply module generates the gate driver voltage and the plurality of data driver voltages for supplying to the AM ChLCD. In comparison with a conventional passive matrix cholesteric liquid crystal display (PM ChLCD) and its displaying method, the AM ChLCD uses active electronic components, enabling the AM ChLCD to be driven with less time needed for refreshing a current display, thus having a higher refresh rate.

Moreover, under same driving voltage conditions, the AM ChLCD is able to display with a higher contrast than the conventional PM ChLCD. This means that the timing controller of the present invention is able to drive the AM ChLCD without needing to iteratively supply the same data driver voltages to drive the AM ChLCD, hence, without needing to store the dynamic image in a large memory. Without needing to implement a large memory, the timing controller of the present invention is able to save implementation cost and decrease the timing controller's physical size. Furthermore, since the timing controller of the present invention is able to drive the AM ChLCD without needing to iteratively supply the same data driver voltages to drive the AM ChLCD for raising contrast, less time is needed for the AM ChLCD to update a frame of the current display. This more efficient way of updating the frame of the current display allows the present invention to be utilized for displaying the dynamic image, which provides a user with a faster, more stable, and more dynamic viewing experience.

Furthermore, since within any two consecutive image display sequences within the set of image display sequences, the overall averaged voltage magnitude of the plurality of data driver voltages outputted by the data driver component is zero, voltages within the said two consecutive image display sequences are without bias. In other words, by driving the AM ChLCD with the data driver voltages of opposite polarities, the present invention is able to prevent polarizations of cholesteric liquid crystal molecules within the AM ChLCD, thus preventing image sticking and uneven brightness in the current display, and increasing a life expectancy of the AM ChLCD.

### BRIEF DESCRIPTION OF THE DRAWINGS

FIG. 1 is a block diagram of a driver system of an active matrix cholesteric liquid crystal display (AM ChLCD) of the present invention and the AM ChLCD.

FIG. 2 is another block diagram of the driver system of the present invention and the AM ChLCD.

FIG. 3A is a signal perspective view of an image control signal of the driver system of the present invention.

FIG. 3B is a signal perspective view of a vertical synchronization signal of the driver system of the present invention.

FIG. 3C is a signal perspective view of a data enable signal of the driver system of the present invention.

FIG. 3D is a waveform perspective view of a data driver voltage received by one of the display units of the driver system of the present invention.

FIG. 3E is a waveform perspective view of a common electrode voltage corresponding to one of the display units of the driver system of the present invention.

FIG. 3F is a waveform perspective view of a voltage difference across one of the display units of the driver system of the present invention.

FIG. 4A is another signal perspective view of the image control signal of the driver system of the present invention.

FIG. 4B is another signal perspective view of the vertical synchronization signal of the driver system of the present invention.

FIG. 4C is another signal perspective view of the data enable signal of the driver system of the present invention.

FIG. 4D is another waveform perspective view of the data driver voltage received by one of the display units of the driver system of the present invention.

FIG. 4E is another waveform perspective view of the common electrode voltage corresponding to one of the display units of the driver system of the present invention.

FIG. 4F is another waveform perspective view of the voltage difference across one of the display units of the driver system of the present invention.

FIG. 5A is another signal perspective view of the image control signal of the driver system of the present invention.

FIG. 5B is another signal perspective view of the vertical synchronization signal of the driver system of the present invention.

FIG. 5C is another signal perspective view of the data enable signal of the driver system of the present invention.

FIG. 5D is another waveform perspective view of the data driver voltage received by one of the display units of the driver system of the present invention.

FIG. 5E is another waveform perspective view of the common electrode voltage corresponding to one of the display units of the driver system of the present invention.

FIG. 5F is another waveform perspective view of the voltage difference across one of the display units of the driver system of the present invention.

FIG. 6A is another signal perspective view of the image control signal of the driver system of the present invention.

FIG. 6B is another signal perspective view of the vertical synchronization signal of the driver system of the present invention.

FIG. 6C is another signal perspective view of the data enable signal of the driver system of the present invention.

FIG. 6D is another waveform perspective view of the data driver voltage received by one of the display units of the driver system of the present invention.

FIG. 6E is another waveform perspective view of the common electrode voltage corresponding to one of the display units of the driver system of the present invention.

FIG. 6F is another waveform perspective view of the voltage difference across one of the display units of the driver system of the present invention.

FIG. 7A is another signal perspective view of the image control signal of the driver system of the present invention.

FIG. 7B is another signal perspective view of the vertical synchronization signal of the driver system of the present invention.

FIG. 7C is another signal perspective view of the data enable signal of the driver system of the present invention.

FIG. 7D is another waveform perspective view of the data driver voltage received by one of the display units of the driver system of the present invention.

FIG. 7E is another waveform perspective view of the common electrode voltage corresponding to one of the display units of the driver system of the present invention.

FIG. 7F is another waveform perspective view of the voltage difference across one of the display units of the driver system of the present invention.

FIG. 8 is another block diagram of the driver system of the present invention.

FIG. 9 is another block diagram of the driver system of the present invention.

FIG. 10 is another block diagram of the driver system of the present invention.

FIG. 11 is a flow chart of a dynamic image displaying method of the AM ChLCD of the present invention.

### DETAILED DESCRIPTION OF THE INVENTION

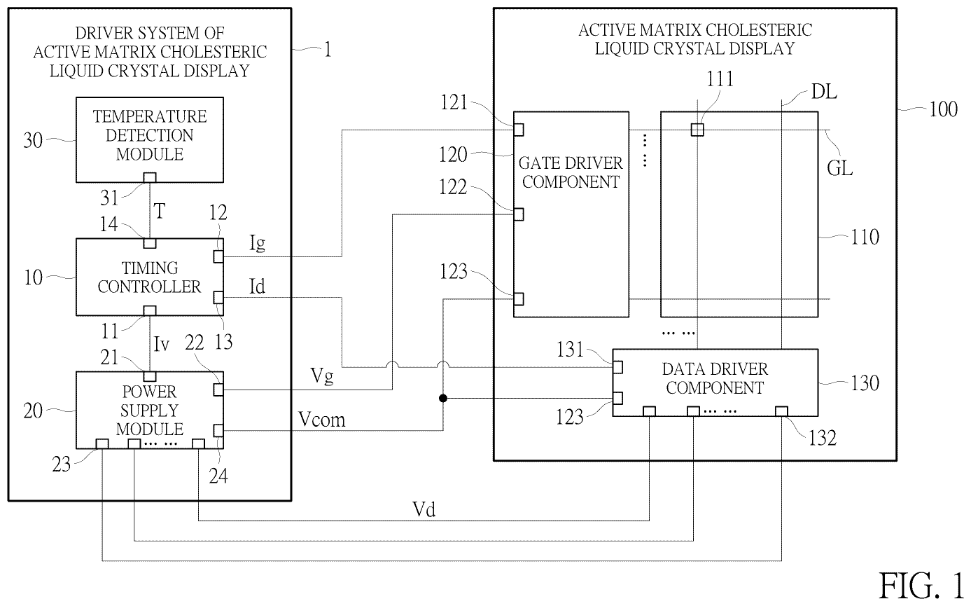

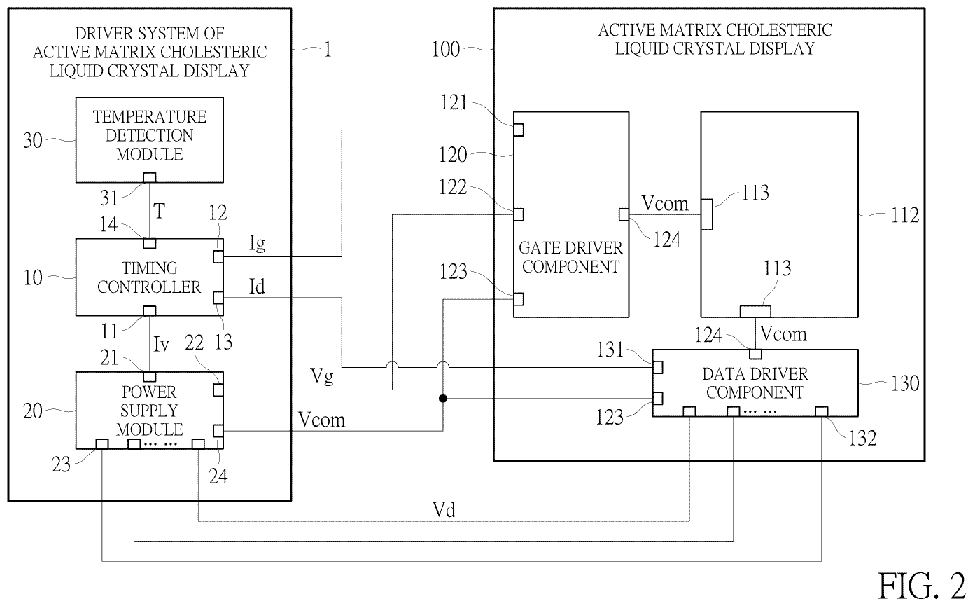

With references to FIG. 1 and FIG. 2, a driver system 1 of an active matrix cholesteric liquid crystal display (AM ChLCD) of the present invention is utilized for driving an active matrix cholesteric liquid crystal display (AM ChLCD) 100 for displaying dynamic images. The driver system 1 includes a timing controller 10 and a power supply module 20. In an embodiment, the timing controller 10 is an integrated circuit (IC) chip, and the timing controller 10 may also be referred to as TCON. In other embodiments, the timing controller 10 may also be an electronic device with processing capabilities, such as a processor or a microcontroller unit (MCU). In the present embodiment, the power supply module 20 is a power supply.

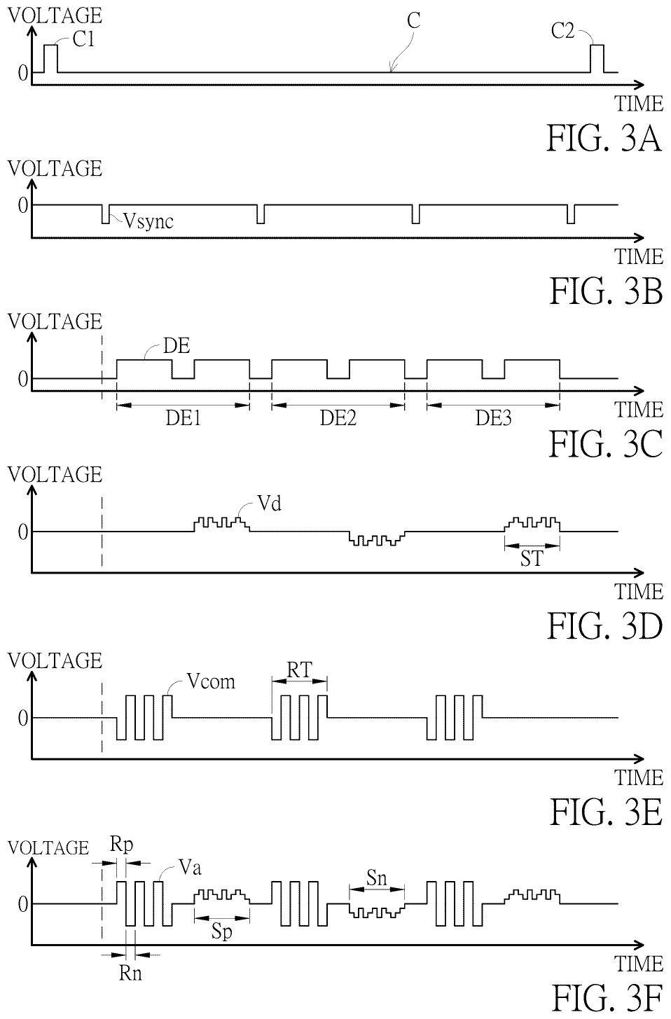

With further references to FIGS. 3A to 3F, the timing controller 10 is connected to the AM ChLCD 100, and the timing controller 10 includes a power control port 11, a gate control port 12, and a data control port 13. The timing controller 10 generates a voltage control command (Iv), a gate control command (Ig), and an image display command (Id) according to a dynamic image parameter data, a data enable signal (DE), and a vertical synchronization signal (Vertical sync, or Vsync). The timing controller 10 outputs the voltage control command (Iv) from the power control port 11 to the power supply module 20, outputs the gate control command (Ig) from the gate control port 12 to the AM ChLCD 100, and outputs the image display command (Id) from the data control port 13 to the AM ChLCD 100. By outputting the voltage control command (Iv), the gate control command (Ig), and the image display command (Id), the timing controller 10 controls the AM ChLCD 100 to execute a set of image reset sequences (RT) and a set of image display sequences (ST). The set of image reset sequences (RT) is executed for resetting a current display of the AM ChLCD 100 multiple times, and the set of image display sequences (ST) is executed for the AM ChLCD 100 to display a dynamic image in the current display.

More particularly, the dynamic image parameter data corresponds to the dynamic image that consists of a plurality of images. The plurality of images are sequentially connected to form the dynamic image. Each pixel in each of the images corresponds to a voltage parameter, and a plurality of the voltage parameters are included in the dynamic image parameter data. Each of the image display sequences (ST) is executed to display one of the images, and the set of image display sequences (ST) as a whole is executed to display the dynamic image. Each of the image reset sequences (RT) is executed to reset the current display of the AM ChLCD 100 once. For example, each of the image reset sequences (RT) is executed to erase a displaying content of the current display and to default the current display into displaying a blank white screen.

The voltage control command (Iv) includes various voltage values required for the AM ChLCD 100 to display the dynamic image and to reset the current display. The gate control command (Ig) includes a chronological sequence for updating every pixel when the AM ChLCD 100 is displaying each of the images of the dynamic image. The image display command (Id) includes an image parameter data of the dynamic image and a voltage value corresponding to each of the pixels when the AM ChLCD is displaying each of the images of the dynamic image.

The data enable signal (DE) defines a time duration of each frame. More particularly, the data enable signal (DE) defines a starting time and an ending time of a frame, and through modifying the time duration of each frame, a refresh rate of the AM ChLCD 100 is configured. The timing controller 10 utilizes the data enable signal (DE) as a reference for controlling the AM ChLCD 100 to chronologically display the dynamic image and for correspondingly generating the gate control command (Ig), the image display command (Id), and the voltage control command (Iv) used for displaying the dynamic image.

The vertical synchronization signal (Vsync) defines a specific time at which the current display changes frames when displaying the dynamic image. Within a triggered period of the vertical synchronization signal (Vsync), the current display remains constant when displaying the dynamic image, and the data enable signal (DE) is triggered for a plurality of times depending on a displaying requirement. In other words, the current display of the dynamic image remains constant within the triggered period of the vertical synchronization signal (Vsync). Moreover, the vertical synchronization signal (Vsync) is utilized for synchronizing the dynamic image between a frontend device and the timing controller 10, and the vertical synchronization signal (Vsync) is also utilized for defining a specific time at which each frame of the dynamic image changes. The frontend device, in an embodiment, is a system on a chip (SoC) device that communicates with the timing controller 10. An explanation of how the SoC device is applied to the present invention will be explained in detail in later parts of the detailed description.

In an embodiment, the timing controller 10 converts the image display command (Id) to a mini low-voltage differential signaling (Mini-LVDS) format before outputting the image display command (Id) to the AM ChLCD 100.

In an embodiment, the timing controller 10 defaults a time duration or a frame number for executing the set of image reset sequences (RT) and the set of image display sequences (ST). When the timing controller 10 determines that the vertical synchronization signal (Vsync) equals a Vsync trigger voltage and the data enable signal (DE) equals an enable trigger voltage, the timing controller 10 first controls the AM ChLCD 100 to execute one of the image reset sequences (RT), and when finishing executing one of the image reset sequences (RT), upon the time when the data enable signal (DE) equals the enable trigger voltage, the timing controller 10 controls the AM ChLCD 100 to execute one of the image display sequences (ST). Moreover, when finishing executing one of the image display sequences (ST), and when the timing controller 10 determines that the vertical synchronization signal (Vsync) again equals the Vsync trigger voltage and the data enable signal (DE) again equals the enable trigger voltage, the timing controller 10 controls the AM ChLCD 100 to execute a subsequent next one of the image reset sequences (RT), and so forth. Overall, before the AM ChLCD 100 executes any one of the image display sequences (ST), the AM ChLCD 100 would first execute one of the image reset sequences (RT), so as to erase the displaying content of the current display. As such, when subsequently executing one of the image display sequences (ST) after executing one of the image reset sequences (RT), the current display of the AM ChLCD 100 may display one of the images of the dynamic image without image sticking.

In an embodiment, the timing controller 10 determines to execute one of the image reset sequences (RT) or one of the image display sequences (ST) according to different voltage values of the data enable signal (DE). When the timing controller 10 determines that the vertical synchronization signal (Vsync) equals the Vsync trigger voltage and the data enable signal (DE) equals a first voltage, the timing controller 10 controls the AM ChLCD 100 to execute one of the image reset sequences (RT). When the timing controller 10 determines that the data enable signal (DE) equals a second voltage, the timing controller 10 controls the AM ChLCD 100 to execute one of the image display sequences (ST). The data enable signal (DE) of the present invention sequentially alternates between the first voltage and the second voltage, thus allowing the timing controller 10 to sequentially alternate between executing the set of image reset sequences (RT) and the set of image display sequences (ST) according to the data enable signal (DE).

The power supply 20 is connected to the timing controller 10 and the AM ChLCD 100. The power supply 20 includes a power communication port 21, a gate driver voltage port 22, a plurality of data driver voltage ports 23, and a common electrode voltage port 24. The power communication port 21 is connected to the power control port 11 of the timing controller 10, and the power supply 20 receives the voltage control command (Iv) outputted from the power control port 11 of the timing controller 10 through the power communication port 21. The gate driver voltage port 22, the plurality of data driver voltage ports 23, and the common electrode voltage port 24 all respectively connect the AM ChLCD 100. The power supply 20 respectively generates a gate driver voltage (Vg), a plurality of data driver voltages (Vd), and a common electrode voltage (Vcom) according to the voltage control command (Iv). The power supply 20 then outputs the gate driver voltage (Vg) from the gate driver voltage port 22, outputs the plurality of data driver voltages (Vd) from the plurality of data driver voltage ports 23, and outputs the common electrode voltage (Vcom) from the common electrode voltage port 24. Each of the data driver voltage ports 23 outputs one of the data driver voltages (Vd).

The power communication port 21 of the power supply 20 communicates with the power control port 11 of the timing controller 10 via an inter-integrated circuit (I²C), thus allowing the timing controller 10 to configure and to control voltage values outputted from the gate driver voltage port 22, each of the data driver voltage ports 23, and the common electrode voltage port 24 of the power supply 20 according to the voltage control command (Iv).

In an embodiment, the power supply 20 configures voltage values and voltage polarities of the gate driver voltage (Vg), the plurality of data driver voltages (Vd), and the common electrode voltage (Vcom) according to each of the voltage parameters included in the voltage control command (Iv). As a result, the power supply 20 is able to generate the gate driver voltage (Vg), the plurality of data driver voltages (Vd), and the common electrode voltage (Vcom) with positive polarity, as well as to generate the gate driver voltage (Vg), the plurality of data driver voltages (Vd), and the common electrode voltage (Vcom) with negative polarity. The power supply 20 outputs the gate driver voltage (Vg) with either the positive polarity or the negative polarity from the gate driver voltage port 22. The power supply 20 outputs the plurality of data driver voltages (Vd) with either the positive polarity or the negative polarity from the data driver voltage ports 23, and the power supply 20 outputs the common electrode voltage (Vcom) with either the positive polarity or the negative polarity from the common electrode voltage port 24.

With references to FIG. 1 and FIG. 2, the AM ChLCD 100 includes a display panel 110, a gate driver component 120, and a data driver component 130. The display panel 110 includes a plurality of display units 111, a common electrode slab 112, and a cholesteric liquid crystal layer. Each of the display units 111 is electrically connected between the gate driver component 120 and the data driver component 130, and each of the display units 111 corresponds to a pixel of the current display displayed by the AM ChLCD 100. Moreover, each of the display units 111 includes at least one transistor. In an embodiment, the at least one transistor may be at least one N-type transistor, with a gate electrically connected to the gate driver component 120, a source electrically connected to the data driver component 130, and a drain electrically connected to the corresponding display unit 111. A plurality of common electrode voltage receiver ports 113 are mounted on the common electrode slab 112. The cholesteric liquid crystal layer is mounted between each of the display units 111 and the common electrode slab 112. Each of the cholesteric liquid crystal layer molecules within the cholesteric liquid crystal layer changes its respective states to particular twisted angles and molecule arrangements according to an electric field created by a voltage difference (Va) between each of the display units 111 and the common electrode slab 112. For each of the display units 111, by determining whether the received data driver voltage (Vd) subtracted by the common electrode voltage (Vcom) of the common electrode slab 112 results in a positive value or a negative value, a polarity of a period is determined. Through controlling changes of the cholesteric liquid crystal layer molecules within the cholesteric liquid crystal layer, the AM ChLCD 100 is able to reset the current display or display the images of the dynamic image for the current display.

The gate driver component 120 includes a gate communication port 121, a gate voltage input port 122, and a plurality of gate lines (GL). The gate communication port 121 and the gate voltage input port 122 are mounted at an input side of the gate driver component 120, and the plurality of gate lines (GL) are mounted at an output side of the gate driver component 120. The gate communication port 121 is connected to the gate control port 12 of the timing controller 10, thus allowing the gate communication port 121 to receive the gate control command (Ig) from the timing controller 10. The gate voltage input port 122 is electrically connected to the gate driver voltage port 22 of the power supply module 20, thus allowing the gate voltage input port 122 to receive the gate driver voltage (Vg) from the power supply module 20. Each of the plurality of gate lines (GL) is able to output the gate driver voltage (Vg), and each of the plurality of gate lines (GL) is respectively connected to the plurality of display units 111 on the same row or column. More particularly, each of the plurality of gate lines (GL) is respectively connected to a gate of the at least one transistor in the plurality of display units 111 on the same row or column. As such, the gate driver voltage (Vg) outputted by the power supply module 20 is able to be delivered to the gate of the at least one transistor in the plurality of display units 111 on the same row or column, thus switching on or switching off the at least one transistor in the plurality of display units 111. Through switching on or switching off the at least one transistor, the corresponding display unit 111 may be controlled. According to the gate control command (Ig), the gate driver component 120 controls a chronological order of when each of the gate lines (GL) outputs the gate driver voltage (Vg). In different embodiments, according to the gate control command (Ig), the gate driver component 120 may control one or more than one of the gate lines (GL) to simultaneously output the gate driver voltage (Vg). In other words, the timing controller 10 may output the gate control command (Ig) for simultaneously driving the plurality of display units 111 connecting to one or more than one of the gate lines (GL).

In an embodiment, the gate driver component 120 includes a common electrode voltage input port 123 and a common electrode voltage output port 124. The common electrode voltage input port 123 is electrically connected to the common electrode voltage port 24 of the power supply module 20, thus allowing the common electrode voltage port 24 to receive the common electrode voltage (Vcom) from the power supply module 20. The common electrode voltage output port 124 is electrically connected to the plurality of common electrode voltage receiver ports 113 of the common electrode slab 112, thus allowing the common electrode voltage (Vcom) to be transported from the plurality of common electrode voltage receiver ports 113 to the common electrode slab 112 for changing an overall voltage potential of the common electrode slab 112 according to the common electrode voltage (Vcom). When the timing controller controls the AM ChLCD 100 to reset the current display, the timing controller 10 outputs the gate control command (Ig), thus controlling the gate driver component 120 to output the common electrode voltage (Vcom) from the common electrode voltage output port 124 to the common electrode slab 112 when executing each of the image reset sequences (RT). This creates the voltage difference (Va) between each of the display units 111 and the common electrode slab 112, and allows the said voltage difference (Va) to be used for resetting the current display of the AM ChLCD 100.

The data driver component 130 includes a data communication port 131, a plurality of data voltage input ports 132, and a plurality of data lines (DL). The data communication port 131 and the plurality of data voltage input ports 132 are mounted on an input side of the data driver component 130, and the plurality of data lines (DL) are mounted on an output side of the data driver component 130. The data communication port 131 is connected to the data control port 13 of the timing controller 10, thus allowing the data communication port 131 to receive the image display command (Id) from the timing controller 10. The plurality of data voltage input ports 132 are electrically connected to the plurality of data driver voltage ports 23 of the power supply module 20, thus allowing the plurality of data voltage input ports 132 to receive the plurality of data driver voltages (Vd) from the power supply module 20. The plurality of data lines (DL) output the plurality of data driver voltages (Vd), and each of the data lines (DL) is respectively connected to the plurality of display units 111 on the same row or column. More particularly, each of the plurality of data lines (DL) is respectively connected to a source of the at least one transistor in the plurality of display units 111 on the same row or column, thus allowing the plurality of data driver voltages (Vd), outputted from the power supply module 20, to correspondingly enter the plurality of display units 111 on the same row or column. The data driver component 130 controls each of the data lines (DL) to output one of the corresponding data driver voltages (Vd) according to the image display command (Id).

In an embodiment, the gate driver component 120 includes a common electrode voltage input port 123 and a common electrode voltage output port 124. The common electrode voltage input port 123 is electrically connected to the common electrode voltage port 24 of the power supply module 20, thus allowing the common electrode voltage port 24 to receive the common electrode voltage (Vcom) from the power supply module 20. The common electrode voltage output port 124 is electrically connected to the plurality of common electrode voltage receiver ports 113 of the common electrode slab 112, thus allowing the common electrode voltage (Vcom) to be transported from the plurality of common electrode voltage receiver ports 113 to the common electrode slab 112 for changing an overall voltage potential of the common electrode slab 112 according to the common electrode voltage (Vcom). When the timing controller 10 controls the AM ChLCD 100 to reset the current display, the timing controller 10 outputs the image display command (Id), thus controlling the data driver component 130 to output the common electrode voltage (Vcom) from the common electrode voltage output port 124 to the common electrode slab 112 when executing each of the image reset sequences (RT). This creates the voltage difference (Va) between each of the display units 111 and the common electrode slab 112, and allows the said voltage difference (Va) to be used for resetting the current display of the AM ChLCD 100.

With reference to FIG. 1, the plurality of gate lines (GL) are parallel with each other and spaced apart from each other along a horizontal direction, and each of the gate lines (GL) is connected to each of the display units 111 on a same row. The plurality of data lines (DL) are parallel with each other and spaced apart from each other along a vertical direction, and each of the data lines (DL) is connected to each of the display units 111 on a same column. Each of the display units 111 is connected to one row of the gate lines (GL) and one column of the data lines (DL). When one of the gate lines (GL) outputs the gate driver voltage (Vg) to one of the display units 111, the said display unit 111 is switched on by the gate driver voltage (Vg), thus allowing one of the data lines (DL) to send in one of the data driver voltages (Vd) to the said display unit 111. As such, the voltage difference (Va) between the said display unit 111 and the common electrode slab 112 is modified by the said data driver voltage (Vd), allowing a grey scale value, a brightness value, and a colorization value corresponding to a pixel of the said display unit 111 to be controlled.

In an embodiment, the at least one transistor of each of the display units 111 is a thin-film transistor (TFT). The gate driver component 120 is a driver IC chip. In the embodiment with the at least one transistor as the at least one N-type transistor, the gate driver component 120 switches on or switches off the gate of the at least one transistor in the display units 111 of a same row or a same column, and thus the gate driver component 120 may also be called a scan driver component. The data driver component 130 may also be a driver IC chip. In the embodiment with the at least one transistor as the at least one N-type transistor, when the gate of the at least one transistor is switched on for each of the display units 111, the data driver component 130 inputs various voltages to the gates. As a result, the voltage difference (Va) between each of the display units 111 and the common electrode slab 112 is modified, allowing the grey scale value, the brightness value, and the colorization value corresponding to the pixel of each of the display units 111 to be controlled.

With reference to FIG. 2, two common electrode voltage receiver ports 113 are mounted on the common electrode slab 112. The gate driver component 120 and the data driver component 130 each respectively include a common electrode voltage input port 123 and a common electrode voltage output port 124. The gate driver component 120 and the data driver component 130 each receive the common electrode voltage (Vcom) from the respective common electrode voltage input port 123, and each outputs the common electrode voltage (Vcom) from the respective common electrode voltage output port 124 to the respective common electrode voltage receiver ports 113 of the common electrode slab 112. In other words, the common electrode voltage output port 124 of the gate driver component 120 is electrically connected to one of the common electrode voltage receiver ports 113 of the common electrode slab 112, and the common electrode voltage output port 124 of the data driver component 130 is electrically connected to another one of the common electrode voltage receiver ports 113 of the common electrode slab 112. When the timing controller 10 controls the AM ChLCD 100 to execute the set of image reset sequences (RT), the timing controller 10 outputs the gate control command (Ig), thus controlling the gate driver component 120 to output the common electrode voltage (Vcom) from one of the common electrode voltage receiver ports 113 to the common electrode slab 112 when executing each of the image reset sequences (RT). The timing controller 10 also outputs the image display command (Id), thus controlling the data driver component 130 to output the common electrode voltage (Vcom) from another one of the common electrode voltage receiver ports 113 to the common electrode slab 112 when executing each of the image reset sequences (RT). As a result, the current display of the AM ChLCD 100 is reset.

When the timing controller 10 controls the AM ChLCD 100 to execute the set of image display sequences (ST), the timing controller 10 outputs the gate control command (Ig), thus controlling a chronological sequence of when the gate driver component 120 outputs the gate driver voltage (Vg) from the plurality of gate lines (GL) when executing each of the image display sequences (ST). The timing controller 10 also outputs the image display command (Id), thus controlling the data driver component 130 to output one of the data driver voltages (Vd) from the plurality of data lines (DL) when executing each of the image display sequences (ST). As a result, the current display of the AM ChLCD 100 is made to sequentially display each of the images of the dynamic image.

Overall, the timing controller 10 generates the voltage control command (Iv), the gate control command (Ig), and the image display command (Id) that correspond to the dynamic image parameter data. The timing controller 10 outputs the voltage control command (Iv), the gate control command (Ig), and the image display command (Id) respectively to the power supply module 20, the gate driver component 120 and the data driver component 130. The timing controller 10 outputs the gate control command (Ig), thus confirming the chronological sequence of at least one transistor within each of the display units 111. With this chronological sequence included in the gate control command (Ig), the gate driver voltage (Vg) is transported to each of the corresponding display units 111 through each of the gate lines (GL), thus switching on or switching off at least one of the transistors in each of the display units 111 according to the gate control command (Ig). Moreover, when each of the display units 111 is switched on, the timing controller 10 configures various data driver voltages (Vd) outputted from the plurality of data lines (DL) to each of the display units 111 according to the image display command (Id). As a result, the pixel corresponding to each of the display units 111 is able to have the voltage difference (Va) between each of the display units 111 and the common electrode slab 112 according to the various data driver voltages (Vd), thus allowing the pixel of each of the display units 111 to display the dynamic image with the corresponding grey scale value, the corresponding brightness value, and the corresponding colorization value.

Please note that the present embodiment only presents one of many possibilities of the AM ChLCD 100 for ease of explaining the driver system of the AM ChLCD 100 and the displaying method thereof. The AM ChLCD 100 is free to be elsewise in other embodiments. The cholesteric liquid crystal layer of the AM ChLCD 100 may be a single-colored cholesteric liquid crystal layer, a dual-colored cholesteric liquid crystal layer, or a multi-colored cholesteric liquid crystal layer.

With references to FIGS. 3A to 3F, a vertical axis of each of FIGS. 3A to 3F represents voltage in units of volt (V), and a horizontal axis of each of FIGS. 3A to 3F represents time in units of millisecond (ms). FIGS. 3D to 3F respectively correspond to the data driver voltages (Vd), the common electrode voltage (Vcom), and the voltage differences (Va) received by one of the display units 111, wherein the voltage differences (Va) are created by the data driver voltages (Vd) and the common electrode voltage (Vcom). A dynamic image display command C1 and a dynamic image termination command C2 are included in an image control signal C. Once the dynamic image display command C1 is triggered, the timing controller 10 controls the AM ChLCD 100 to execute the set of image reset sequences (RT) and the set of image display sequences (ST). Once the dynamic image termination command C2 is triggered, the timing controller 10 controls the AM ChLCD 100 to stop executing the set of image reset sequences (RT) and the set of image display sequences (ST).

When the dynamic image display command C1 is triggered, the timing controller 10 configures a chronological sequence of executing the set of image reset sequences (RT) and the set of image display sequences (ST) according to a periodicity of the data enable signal (DE). For example, for the embodiment shown in FIGS. 3A to 3F, when the data enable signal (DE) is triggered (as shown in FIG. 3D with the data enable signal (DE) being at a higher voltage), the timing controller 10 controls the AM ChLCD 100 to execute either the set of image reset sequences (RT) or the set of image display sequences (ST). If the timing controller 10 configures a time duration of one of the image reset sequences (RT) to be as long as a time duration that the data enable signal (DE) takes to be triggered, and the timing controller 10 also configures a time duration of one of the image display sequences (ST) to be as long as the time duration that the data enable signal (DE) takes to be triggered, then the timing controller 10 is able to analogously view an enabled period (DE1, DE2, DE3) as being defined as a time duration of the data enable signal (DE) being triggered twice. Within each of the enabled periods (DE1, DE2, DE3), the timing controller 10 controls the AM ChLCD 100 to execute one image reset sequence (RT) and one image display sequence (ST). Between the different enabled periods (DE1, DE2, DE3), the timing controller 10 transports image data of different images.

Each of the image reset sequences (RT) includes at least one positive polarity reset period (Rp) and at least one negative polarity reset period (Rn). When the AM ChLCD 100 resets the current display, the at least one positive polarity reset period (Rp) and the at least one negative polarity reset period (Rn) are distinguished and determined according to the voltage difference (Va) between each of the display units 111 and the common electrode slab 112. Within the at least one positive polarity reset period (Rp), one of the display units 111 receives the common electrode voltage (Vcom) with negative polarity from the common electrode slab 112. Within the at least one negative polarity reset period (Rn), one of the display units 111 receives the common electrode voltage (Vcom) with positive polarity from the common electrode slab 112. A voltage magnitude of the common electrode voltage (Vcom) with positive polarity equals a voltage magnitude of the common electrode voltage (Vcom) with negative polarity. A total duration of the at least one positive polarity reset period (Rp) equals a total duration of the at least one negative polarity reset period (Rn). Since the common electrode voltage (Vcom) with negative polarity and the common electrode voltage (Vcom) with positive polarity are equal both in time durations and in voltage magnitudes, within each of the image reset sequences (RT), a total voltage average of adding the common electrode voltage (Vcom) with positive polarity and adding the common electrode voltage (Vcom) with negative polarity equals zero volt.

With references to FIGS. 3A to 3F, in an embodiment, each of the image reset sequences (RT) includes a plurality of positive polarity reset periods (Rp) and a plurality of negative polarity reset periods (Rn). Within each of the image reset sequences (RT), the positive polarity reset periods (Rp) and the negative polarity reset periods (Rn) are sequentially arranged in an alternating order. This means that one of the positive polarity reset periods (Rp) is sequentially arranged to be between two of the negative polarity reset periods (Rn), and that one of the negative polarity reset periods (Rn) is sequentially arranged to be between two of the positive polarity reset periods (Rp).

With references to FIGS. 3D to 3F, in an embodiment, within the set of image reset sequences (RT), the data driver component 130 does not output any of the data driver voltages (Vd) to any of the display units 111, which means that one of the display units 111 receives the data driver voltage (Vd) with zero volt. The display units 111 are mounted on a pixel electrode slab, and a voltage difference between the pixel electrode slab and the common electrode slab 112 equals the common electrode voltage (Vcom) received by the common electrode slab 112. Therefore, within the set of image reset sequences (RT), a waveform of the voltage difference (Va) for one of the display units 111 is equal to a waveform of the common electrode voltage (Vcom) with opposite polarities. In other words, the data driver voltage (Vd) with zero volt minus the common electrode voltage (Vcom) equals the voltage difference (Va) with opposite polarities to the common electrode voltage (Vcom).

As the timing controller 10 controls the AM ChLCD 100 to execute the set of image display sequences (ST), within any two consecutive image display sequences (ST) within the set of image display sequences (ST), an averaged voltage magnitude of the plurality of data driver voltages (Vd) outputted by the data driver component 130 within one of the two consecutive image display sequences (ST) equals an averaged voltage magnitude of the plurality of data driver voltages (Vd) outputted by the data driver component 130 within the other one of the two consecutive image display sequences (ST) but with opposite voltage polarities. As a result within any two consecutive image display sequences (ST) within the set of image display sequences (ST), an overall averaged voltage magnitude of the plurality of data driver voltages (Vd) outputted by the data driver component 130 is zero.

Moreover, within any two consecutive image display sequences (ST), at least one positive polarity display period (Sp) and at least one negative polarity display period (Sn) are included. In other words, after the AM ChLCD 100 is reset and started consecutively displaying any two frames of the images, the at least one positive polarity display period (Sp) and the at least one negative polarity display period (Sn) are distinguished and determined according to the voltage difference (Va) between each of the display units 111 and the common electrode slab 112. Within the at least one positive polarity display period (Sp), one of the display units 111 receives the plurality of data driver voltages (Vd) with positive polarity from the data driver component 130. Within the at least one negative polarity display period (Sn), one of the display units 111 receives the plurality of data driver voltages (Vd) with negative polarity from the data driver component 130.

Within any two consecutive image display sequences (ST), an averaged voltage magnitude of the plurality of data driver voltages (Vd) within each positive polarity display period (Sp) equals an averaged voltage magnitude of the plurality of data driver voltages (Vd) within each negative polarity display period (Sn). Moreover, a number of the at least one positive polarity display period (Sp) equals a number of the at least one negative polarity display period (Sn), and a total duration of each positive polarity display period (Sp) equals a total duration of each negative polarity display period (Sn). Since the data driver voltages (Vd) with positive polarity and the data driver voltages (Vd) with negative polarity are equal both in time durations and in averaged voltage magnitudes, within any two consecutive image display sequences (ST), a total voltage average of adding the data driver voltages (Vd) with positive polarity and the data driver voltages (Vd) with negative polarity equals zero volt.

In an embodiment, within any two consecutive image display sequences (ST), each positive polarity display periods (Sp) is paired with one of the negative polarity display periods (Sn). Within any pair of the positive polarity display period (Sp) and the negative polarity display period (Sn), an averaged voltage magnitude of the plurality of data driver voltages (Vd) within the said positive polarity display period (Sp) equals an averaged voltage magnitude of the plurality of data driver voltages (Vd) within the said negative polarity display period (Sn).

In the embodiment shown in FIGS. 3A to 3F, each image display sequence (ST) includes one positive polarity display period (Sp) or one negative polarity display period (Sn). Therefore, within any two consecutive image display sequences (ST), one of the image display sequences (ST) includes the one positive polarity display period (Sp), and the other one of the image display sequences (ST) includes the one negative polarity display period (Sn). In other words, the timing controller 10 controls the AM ChLCD 100 to alternate between executing an image display sequence (ST) that has the positive polarity display period (Sp) and an image display sequence (ST) that has the negative polarity display period (Sn).

With references to FIGS. 3D to 3F, within the plurality of image display sequences (ST), the common electrode slab 112 does not receive any of the common electrode voltages (Vcom), and thus the common electrode slab 112 remains zero volt. As the display units 111 are mounted on the pixel electrode slab, the voltage difference between each of the display units 111 on the pixel electrode slab and the common electrode slab 112 equals each of the data driver voltages (Vd). Therefore, within each plurality of image display sequences (ST), a waveform of the voltage difference (Va) for one of the display units 111 is equal to a waveform of one of the data driver voltages (Vd). In other words, one of the data driver voltages (Vd) minus the common electrode voltage (Vcom) with zero volt equals the voltage difference (Va) that is correspondingly equal to one of the data driver voltages (Vd).

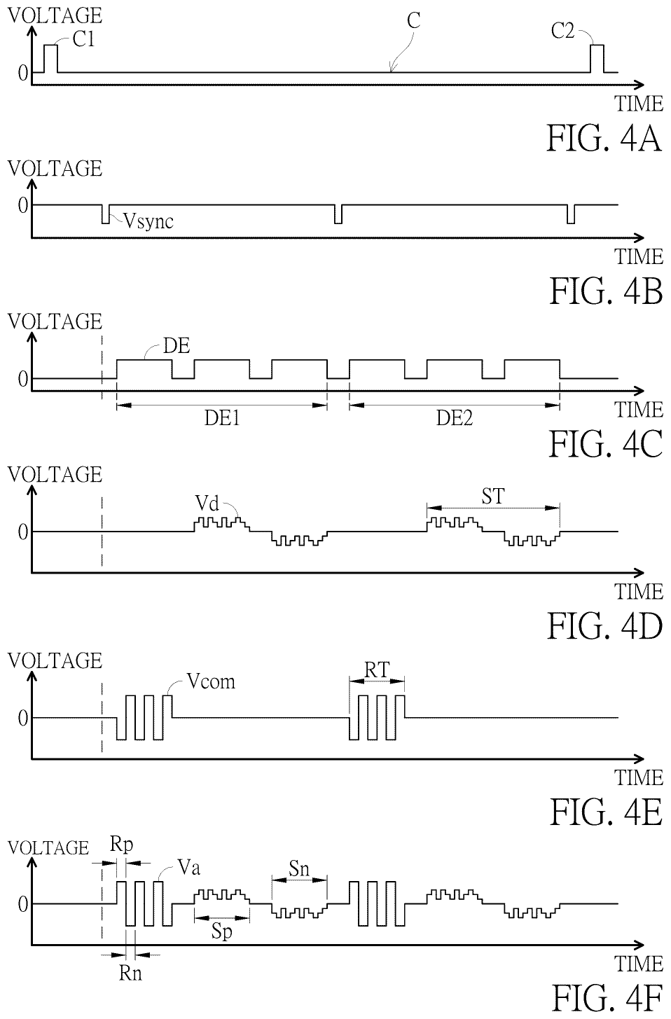

With references to FIGS. 4A to 4F, a vertical axis of each of FIGS. 4A to 4F represents voltage in units of volt (V), and a horizontal axis of each of FIGS. 4A to 4F represents time in units of millisecond (ms). FIGS. 4D to 4F respectively correspond to the data driver voltages (Vd), the common electrode voltage (Vcom), and the voltage differences (Va) received by one of the display units 111, wherein the voltage differences (Va) are created by the data driver voltages (Vd) and the common electrode voltage (Vcom). The dynamic image display command C1 and the dynamic image termination command C2 are included in an image control signal C. Once the dynamic image display command C1 is triggered, the timing controller 10 controls the AM ChLCD 100 to execute the set of image reset sequences (RT) and the set of image display sequences (ST). Once the dynamic image termination command C2 is triggered, the timing controller 10 controls the AM ChLCD 100 to stop executing the set of image reset sequences (RT) and the set of image display sequences (ST).

With references to FIGS. 4A to 4F, in an embodiment, each of the image display sequences (ST) includes at least one positive polarity display period (Sp) and at least one negative polarity display period (Sn). A number of the at least one positive polarity display period (Sp) equals a number of the at least one negative polarity display period (Sn), and a total duration of each positive polarity display period (Sp) equals a total duration of each negative polarity display period (Sn). Within each of the image display sequences (ST), an averaged voltage magnitude of the plurality of data driver voltages (Vd) within the at least one positive polarity display period (Sp) equals an averaged voltage magnitude of the plurality of data driver voltages (Vd) within the at least one negative polarity display period (Sn). Since the data driver voltages (Vd) with positive polarity and the data driver voltages (Vd) with negative polarity are equal both in time durations and in averaged voltage magnitudes, within each image display sequence (ST), a total voltage average of adding the data driver voltages (Vd) with positive polarity and the data driver voltages (Vd) with negative polarity equals zero volt.

Furthermore, the timing controller 10 controls the AM ChLCD 100 to execute the set of image reset sequences (RT) and the set of image display sequences (ST). If the timing controller 10 configures a time duration of one of the image reset sequences (RT) to be as long as a time duration that the data enable signal (DE) takes to be triggered, and if the timing controller 10 also configures a time duration of one of the image display sequences (ST) to be twice as long as the time duration that the data enable signal (DE) takes to be triggered, then the timing controller 10 is able to analogously view an enabled period (DE1, DE2) as being defined as a time duration of the data enable signal (DE) being triggered three times. Within each of the enabled periods (DE1, DE2), the timing controller 10 controls the AM ChLCD 100 to execute one image reset sequence (RT) and two of the image display sequences (ST).

In the embodiment shown in FIGS. 4A to 4F, each image display sequence (ST) includes one positive polarity display period (Sp) and one negative polarity display period (Sn). Each image display sequence (ST) may also include a plurality of positive polarity display periods (Sp) and a plurality of negative polarity display periods (Sn).

In an embodiment, when each image display sequence (ST) includes the plurality of positive polarity display periods (Sp) and the plurality of negative polarity display periods (Sn), the positive polarity display period (Sp) and the negative polarity display period (Sn) are sequentially arranged in an alternating order. This means that one of the positive polarity display periods (Sp) is sequentially arranged to be between two of the negative polarity display periods (Sn), and that one of the negative polarity display periods (Sn) is sequentially arranged to be between two of the positive polarity display periods (Sp). Please note that, as the total voltage average of adding the data driver voltages (Vd) with positive polarity plus the data driver voltages (Vd) with negative polarity equals zero volt within each image display sequence (ST), the positive polarity display periods (Sp) and the negative polarity display periods (Sn) within each image display sequence (ST) may be sequentially arranged in any arbitrary order elsewise than the present embodiment.

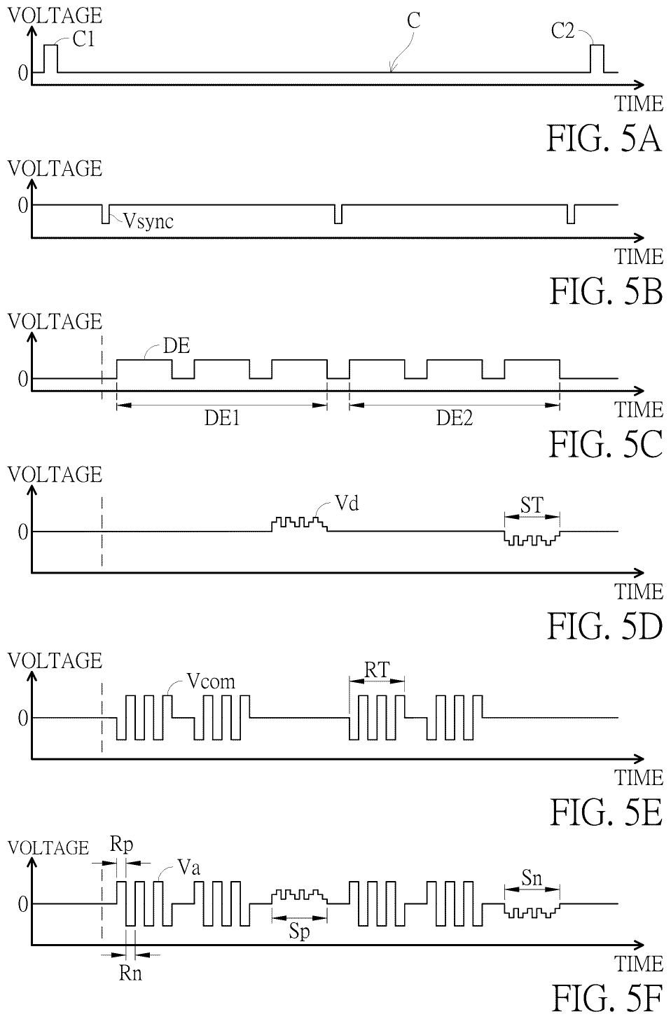

With references to FIGS. 5A to 5F, a vertical axis of each of FIGS. 5A to 5F represents voltage in units of volt (V), and a horizontal axis of each of FIGS. 5A to 5F represents time in units of millisecond (ms). FIGS. 5D to 5F respectively correspond to the data driver voltages (Vd), the common electrode voltage (Vcom), and the voltage differences (Va) received by one of the display units 111, wherein the voltage differences (Va) are created by the data driver voltages (Vd) and the common electrode voltage (Vcom).

The embodiment depicted in FIGS. 5A to 5F differs from the embodiment depicted in FIGS. 3A to 3F in that, although the timing controller 10 configures a time duration of one of the image reset sequences (RT) to be as long as a time duration that the data enable signal (DE) takes to be triggered, the timing controller 10 is configured to execute the image reset sequence (RT) twice for each time the timing controller 10 executes the set of image reset sequences (RT) to reset the AM ChLCD 100. Furthermore, a time duration of one of the image display sequences (ST) is configured to be as long as the time duration that the data enable signal (DE) takes to be triggered. The timing controller 10 is able to analogously view an enabled period (DE1, DE2) as being defined as a time duration of the data enable signal (DE) being triggered three times. Within each of the enabled periods (DE1, DE2), the timing controller 10 controls the AM ChLCD 100 to execute two image reset sequences (RT) and one image display sequence (ST).

By comparing the embodiment depicted in FIGS. 3A to 3F to the embodiment depicted in FIGS. 5A to 5F, overall, regardless of a time duration of the plurality of image reset sequences (RT), within each of the image reset sequences (RT), the at least one positive polarity reset period (Rp) and the at least one negative polarity reset period (Rn) have same total time durations, same voltage magnitudes, and opposite voltage polarities. In two consecutive image display sequences (ST) or one image display sequence (ST), overall, the at least one positive polarity display period (Sp) and the at least one negative polarity display period (Sn) have same total time durations, same voltage magnitudes, and opposite voltage polarities. As a result, regardless of executing the set of image reset sequences (RT) or the set of image display sequences (ST), the driver system 1 is supplying the AM ChLCD 100 with voltages that are same in voltage magnitudes but opposite in voltage polarities. As a result, the present invention is able to prevent the cholesteric liquid crystal layer molecules within the AM ChLCD 100 from being permanently polarized, and thus preventing the AM ChLCD 100 from displaying abnormally with image sticking and uneven brightness in the current display.

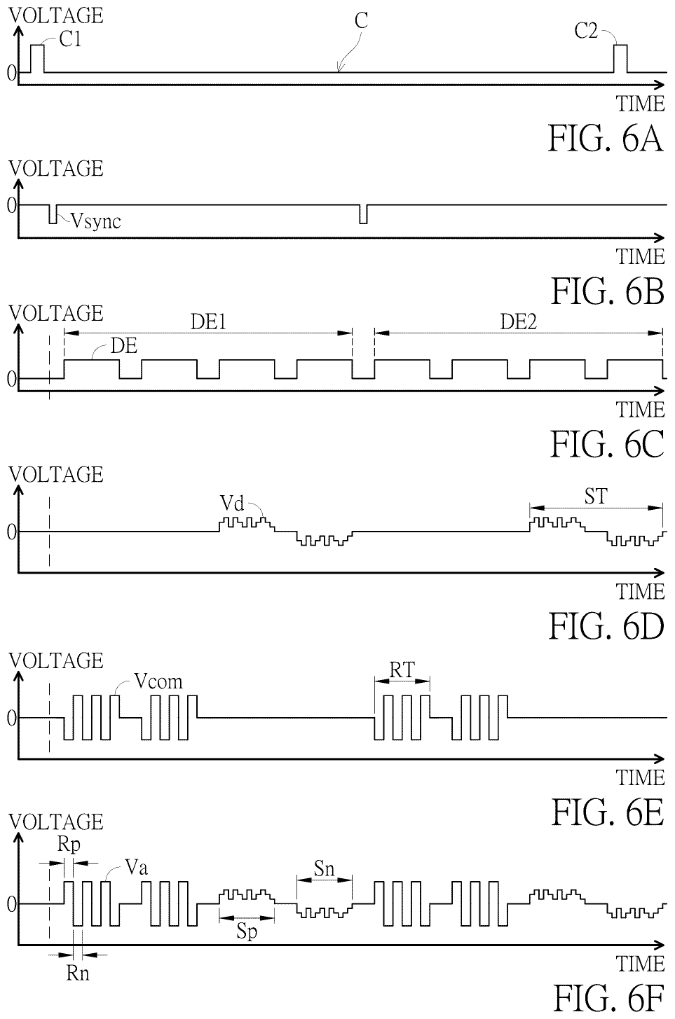

With references to FIGS. 6A to 6F, a vertical axis of each of FIGS. 6A to 6F represents voltage in units of volt (V), and a horizontal axis of each of FIGS. 6A to 6F represents time in units of millisecond (ms). FIGS. 6D to 6F respectively correspond to the data driver voltages (Vd), the common electrode voltage (Vcom), and the voltage differences (Va) received by one of the display units 111, wherein the voltage differences (Va) are created by the data driver voltages (Vd) and the common electrode voltage (Vcom).

The embodiment depicted in FIGS. 6A to 6F differs from the embodiment depicted in FIGS. 4A to 4F in that, although the timing controller 10 configures a time duration of one of the image reset sequences (RT) to be as long as a time duration that the data enable signal (DE) takes to be triggered, the timing controller 10 is configured to execute the image reset sequence (RT) twice for each time the timing controller 10 executes the set of image reset sequences (RT) to reset the AM ChLCD 100. Furthermore, a time duration of one of the image display sequences (ST) is configured to be twice as long as the time duration that the data enable signal (DE) takes to be triggered. The timing controller 10 is able to analogously view an enabled period (DE1, DE2) as being defined as a time duration of the data enable signal (DE) being triggered four times. Within each of the enabled periods (DE1, DE2), the timing controller 10 controls the AM ChLCD 100 to execute two image reset sequences (RT) and one image display sequence (ST).

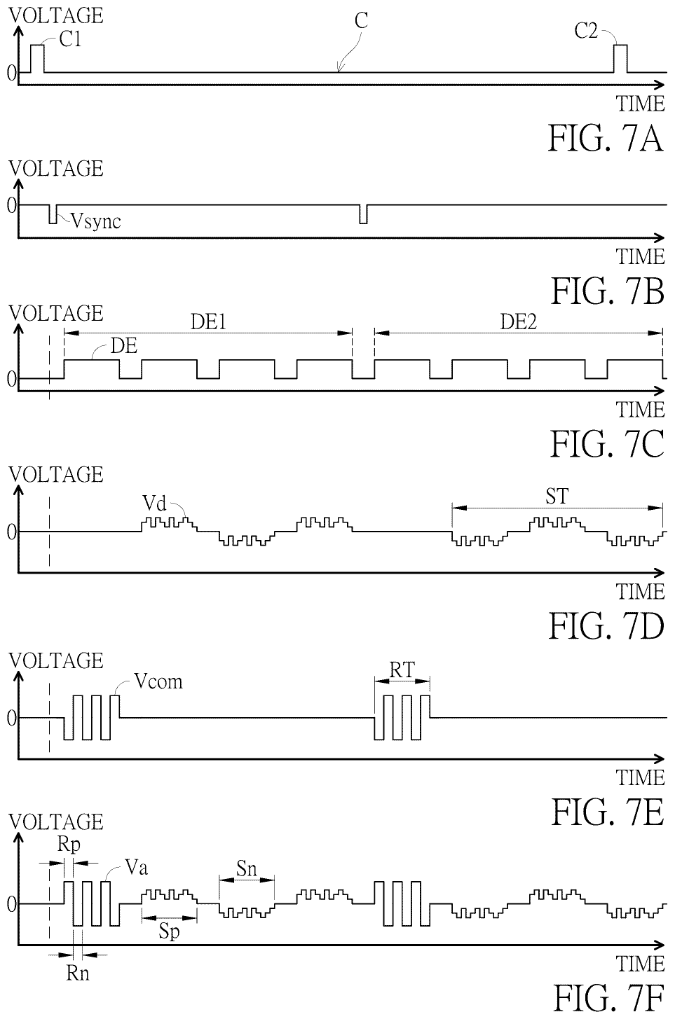

With references to FIGS. 7A to 7F, a vertical axis of each of FIGS. 7A to 7F represents voltage in units of volt (V), and a horizontal axis of each of FIGS. 7A to 7F represents time in units of millisecond (ms). FIGS. 7D to 7F respectively correspond to the data driver voltages (Vd), the common electrode voltage (Vcom), and the voltage differences (Va) received by one of the display units 111, wherein the voltage differences (Va) are created by the data driver voltages (Vd) and the common electrode voltage (Vcom).

In the embodiment shown in FIGS. 7A to 7F, each of the image display sequences (ST) includes at least one positive polarity display period (Sp) and at least one negative polarity display period (Sn). A number of the at least one positive polarity display period (Sp) equals a number of the at least one negative polarity display period (Sn), and a total duration of the at least one positive polarity display period (Sp) equals a total duration of the at least one negative polarity display period (Sn). Within each of the image display sequences (ST), an averaged voltage magnitude of the plurality of data driver voltages (Vd) within the at least one positive polarity display period (Sp) equals an averaged voltage magnitude of the plurality of data driver voltages (Vd) within the at least one negative polarity display period (Sn). Since the data driver voltages (Vd) with positive polarity and the data driver voltages (Vd) with negative polarity are equal both in time durations and in averaged voltage magnitudes, a total voltage average of adding the data driver voltages (Vd) with positive polarity within one positive polarity display period (Sp) and the data driver voltages (Vd) with negative polarity within one negative polarity display period (Sn) equals zero volt.

Moreover, within any two consecutive image display sequences (ST), an averaged voltage magnitude of the plurality of data driver voltages (Vd) received from the data driver component 130 within one of the image display sequences (ST) equals an averaged voltage magnitude of the plurality of data driver voltages (Vd) received from the data driver component 130 within the other one of the image display sequences (ST). A voltage polarity of the averaged voltage magnitude of the plurality of data driver voltages (Vd) received from the data driver component 130 within one of the image display sequences (ST) is opposite of a voltage polarity of the averaged voltage magnitude of the plurality of data driver voltages (Vd) received from the data driver component 130 within the other one of the image display sequences (ST). As a result, within any two consecutive image display sequences (ST), a total averaged voltage of the plurality of data driver voltages (Vd) received from the data driver component 130 is zero volt.

Furthermore, in the present embodiment depicted in FIGS. 7A to 7F, any two consecutive image display sequences (ST) includes a plurality of positive polarity display periods (Sp) and a plurality of negative polarity display periods (Sn). For example, of two consecutive image display sequences (ST), with one image display sequence (ST) including two positive polarity display periods (Sp) and one negative polarity display period (Sn), and with a subsequent one image display sequence (ST) including one positive polarity display period (Sp) and two negative polarity display periods (Sn), the timing controller 10 controls the AM ChLCD 100 to sequentially pair each positive polarity display period (Sp) with one of the negative polarity display periods (Sn) within each execution of the image display sequence (ST).

In an embodiment, within any two consecutive image display sequences (ST), each positive polarity display periods (Sp) is paired with one of the negative polarity display periods (Sn). Within any pair of the positive polarity display period (Sp) and the negative polarity display period (Sn), an averaged voltage magnitude of the plurality of data driver voltages (Vd) within the said positive polarity display period (Sp) equals an averaged voltage magnitude of the plurality of data driver voltages (Vd) within the said negative polarity display period (Sn).

The embodiment depicted in FIGS. 7A to 7F also differs from the embodiment depicted in FIGS. 4A to 4F in that, the timing controller 10 configures a time duration of one of the image reset sequences (RT) to be as long as a time duration that the data enable signal (DE) takes to be triggered, and the timing controller 10 configures a time duration of one of the image display sequences (ST) to be three times as long as a time duration that the data enable signal (DE) takes to be triggered. The timing controller 10 is able to analogously view an enabled period (DE1, DE2) as being defined as a time duration of the data enable signal (DE) being triggered four times. Within each of the enabled periods (DE1, DE2), the timing controller 10 controls the AM ChLCD 100 to execute one image reset sequence (RT) and one image display sequence (ST).

In an embodiment, any two consecutive image display sequences (ST) include a plurality of positive polarity display periods (Sp) and a plurality of negative polarity display periods (Sn). For example, of two consecutive image display sequences (ST), with one image display sequence (ST) including three positive polarity display periods (Sp), and with a subsequent one image display sequence (ST) including three negative polarity display periods (Sn); or, of two consecutive image display sequences (ST), with one image display sequence (ST) including two positive polarity display periods (Sp) and one negative polarity display period (Sn), and with a subsequent one image display sequence (ST) including one positive polarity display period (Sp) and two negative polarity display periods (Sn). Please note that arrangements of a number of the plurality of positive polarity display periods (Sp) and a number of the plurality of negative polarity display periods (Sn) within two consecutive image display sequences (ST) are free to be elsewise in other embodiments.

Furthermore, by comparing the embodiment depicted in FIGS. 3A to 3F to the embodiment depicted in FIGS. 7A to 7F, when the timing controller 10 determines that the image control signal C equals a trigger voltage and thus receives the dynamic image display command C1, the timing controller 10 controls the AM ChLCD 100 to execute the set of image reset sequences (RT) and the set of image display sequences (ST). Subsequently, when the timing controller 10 determines that the image control signal C again equals the trigger voltage and thus receives the dynamic image termination command C2, the timing controller 10 controls the AM ChLCD 100 to stop executing the set of image reset sequences (RT) and the set of image display sequences (ST).

In the example shown in FIGS. 3A to 3F, when the timing controller 10 determines that the image control signal C equals the trigger voltage, the timing controller 10 controls the AM ChLCD 100 to execute the set of image reset sequences (RT) and the set of image display sequences (ST). Subsequently, after the timing controller 10 controls the AM ChLCD 100 to execute the image display sequence (ST) for the second time, when the timing controller 10 determines that the image control signal C again equals the trigger voltage, the timing controller 10 controls the AM ChLCD 100 to stop executing the set of image reset sequences (RT) and the set of image display sequences (ST). As a result, the current display of the AM ChLCD 100 is paused from displaying the plurality of images of the dynamic image, and the current display of the AM ChLCD 100 remains showing the image that is displayed from the second time execution of the image display sequence (ST) on the AM ChLCD 100.

With reference to FIG. 1, in an embodiment, the driver system 1 of the AM ChLCD 100 includes a temperature detection module 30. The temperature detection module 30 includes a temperature signal output port 31, and the timing controller 10 includes a temperature communication port 14. The temperature signal output port 31 of the temperature detection module 30 is connected to the temperature communication port 14 of the timing controller 10. The temperature detection module 30 is either placed inside of the AM ChLCD 100 or on the AM ChLCD 100. For example, in an embodiment, the temperature detection module 30 is mounted on a circuit board within the AM ChLCD 100. In another embodiment, the temperature detection module 30 is mounted on an exterior surface of the AM ChLCD 100. The temperature detection module 30 detects a device temperature of the AM ChLCD 100 and generates a temperature signal T according to the device temperature. The temperature detection module 30 outputs the temperature signal T through the temperature signal output port 31 to the temperature communication port 14 of the timing controller 10. In an embodiment, the temperature signal output port 31 of the temperature detection module 30 communicates with the temperature communication port 14 of the timing controller 10 through an inter-integrated circuit (I²C).

A viscosity and an attraction force between the cholesteric liquid crystals are dependent on the device temperature of the AM ChLCD 100, and moreover, the viscosity and the attraction force between the cholesteric liquid crystals also affect an amount of voltage needed to drive the cholesteric liquid crystals. Namely, the higher the viscosity and the higher the attraction force between the cholesteric liquid crystals are, a greater amount of voltage is needed to drive the cholesteric liquid crystals of the AM ChLCD 100; and the lower the viscosity and the lower the attraction force between the cholesteric liquid crystals are, a less amount of voltage is needed to drive the cholesteric liquid crystals of the AM ChLCD 100. By having the timing controller 10 storing a temperature-to-voltage table, a relationship between the device temperature of the AM ChLCD 100 and the amount of voltage needed to drive the AM ChLCD 100 is defaulted. In an embodiment, the temperature-to-voltage table records a plurality of possible device temperatures of the AM ChLCD 100 in various situations, and for each of the possible device temperatures of the AM ChLCD 100, the temperature-to-voltage table records various voltage values needed to drive the AM ChLCD 100 for displaying or resetting the current display.

When the timing controller 10 receives the temperature signal T, the timing controller 10 adjusts the voltage control command (Iv) according to the temperature signal T, and the timing controller 10 outputs the voltage control command (Iv) to the power supply module 20. Through adjusting the voltage control command (Iv), the timing controller 10 is able to configure voltage values of the gate driver voltage (Vg), the plurality of data driver voltages (Vd), and the common electrode voltage (Vcom) that are outputted by the power supply module 20. As such, the timing controller 10 is able to adjust various voltages outputted from the power supply module 20 to the AM ChLCD 100 according to the device temperature of the AM ChLCD 100.

For example, when the device temperature of the AM ChLCD 100 rises, the timing controller 10 determines how much the various voltages that are driving the AM ChLCD 100 should be decreased according to the temperature signal T and the temperature-to-voltage table. Once determined, the timing controller 10 then adjusts the voltage control command (Iv) and outputs the voltage control command (Iv) to the power supply module 20 for decreasing the voltage values of the gate driver voltage (Vg), the plurality of data driver voltages (Vd), and the common electrode voltage (Vcom). Vice versa, when the device temperature of the AM ChLCD 100 lowers, the timing controller 10 determines how much the various voltages that are driving the AM ChLCD 100 should be increased according to the temperature signal T and the temperature-to-voltage table. Once determined, the timing controller 10 then adjusts the voltage control command (Iv) and outputs the voltage control command (Iv) to the power supply module 20 for increasing the voltage values of the gate driver voltage (Vg), the plurality of data driver voltages (Vd), and the common electrode voltage (Vcom).

By taking the device temperature into account, the timing controller 10 is able to even better regulate the voltages needed to drive the AM ChLCD 100, ensuring that no more than necessary amount of electric power is wasted, ensuring high energy efficiency for driving the AM ChLCD 100, and ensuring the AM ChLCD 100 is able to display the current display with adequate brightness and colorization under various temperature conditions.

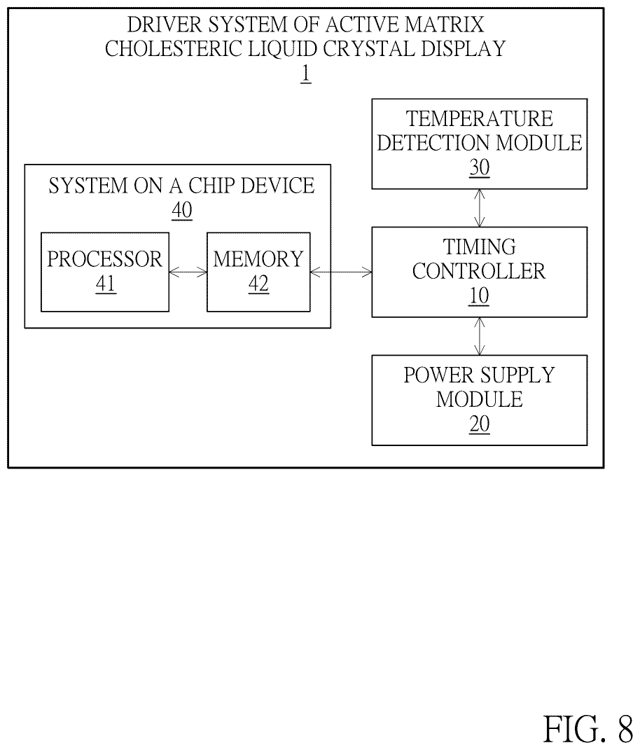

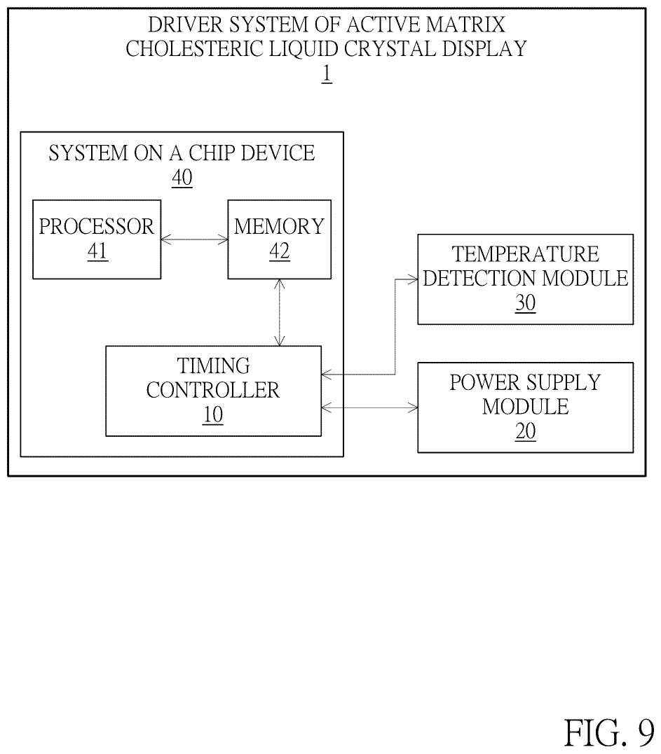

With references to FIG. 8 and FIG. 9, the driver system 1 of the AM ChLCD 100 is utilized as a system on a chip (SoC). For example, the SoC includes a system on a chip (SoC) device 40, the SoC device 40 includes a processor 41 and a memory 42, and the processor 41 is electrically connected to the memory 42. The processor 41 processes a dynamic image data, wherein the dynamic image data includes a plurality of images of a dynamic image, and thus, the processor 41 generates the dynamic image parameter data according to a voltage parameter of each of the pixels that are included in each of the images of the dynamic image in the dynamic image data. The processor 41 generates the vertical synchronization signal (Vsync) and the data enable signal (DE) that corresponds to the dynamic image parameter data, and the processor 41 stores the dynamic image parameter data, the vertical synchronization signal (Vsync), and the data enable signal (DE) in the memory 42. The memory 42 is connected to the timing controller 10, and the timing controller 10 receives the dynamic image parameter data, the vertical synchronization signal (Vsync), and the data enable signal (DE) from the memory 42. In an embodiment, the processor 41 configures a time duration of the set of image reset sequences (RT) and/or a time duration of the set of image display sequences (ST) according to chronological sequences of the dynamic image parameter data, of the vertical synchronization signal (Vsync), and of the data enable signal (DE).

With reference to FIG. 8, in an embodiment, the timing controller 10 is a piece of hardware that is mounted outside of the SoC device 40 and connected to the SoC device 40 for receiving the dynamic image parameter data, the vertical synchronization signal (Vsync), and the data enable signal (DE) from the SoC device 40. Moreover, in an embodiment, the SoC device 40 communicates to the timing controller 10 for transporting the dynamic image parameter data, the vertical synchronization signal (Vsync), and the data enable signal (DE) through serial peripheral interface bus (SPI) with low-voltage differential signaling (LVDS). In another embodiment, the SoC device 40 communicates to the timing controller 10 for transporting the dynamic image parameter data, the vertical synchronization signal (Vsync), and the data enable signal (DE) through mobile industry processor interface (MIPI).

With reference to FIG. 9, in an embodiment, the timing controller 10 is a timing controlling software that is installed in the SoC device 40 and connected to the memory 42 for receiving the dynamic image parameter data, the vertical synchronization signal (Vsync), and the data enable signal (DE) from the SoC device 40.

In an embodiment, the memory 42 stores a device characteristic information, the device characteristic information includes a relationship data that characterizes a driving time required for using various voltages to drive different materials of the cholesteric liquid crystals in the AM ChLCD 100. The different materials of the cholesteric liquid crystals in the AM ChLCD 100 characteristically entail different viscosities, different fluidities, different molecular distances, and different molecular arrangements of the cholesteric liquid crystals. For example, under same driving voltage conditions, the higher the viscosity of the cholesteric liquid crystals in the AM ChLCD 100, the longer time duration the AM ChLCD 100 needs to drive the cholesteric liquid crystals, so as to adequately twist and adjust the cholesteric liquid crystals into a certain arrangement.

As the processor 41 adjusts the dynamic image parameter data, the vertical synchronization signal (Vsync), and the data enable signal (DE) according to the device characteristic information, the processor 41 configures the time duration of the set of image reset sequences (RT) and/or the time duration of the set of image display sequences (ST) according to the chronological sequences of the dynamic image parameter data, of the vertical synchronization signal (Vsync), and of the data enable signal (DE). For example, the processor 41 is able to configure a number of frames included in the set of image reset sequences (RT) and/or in the set of image display sequences (ST).

For example, according to a characterization of a material of the cholesteric liquid crystals in the AM ChLCD 100, and according to the corresponding voltage required to drive the said material as detailed in the device characteristic information, when the AM ChLCD 100 is required to drive the cholesteric liquid crystals with a longer driving time, the processor 41 then accordingly increases the time duration of the set of image reset sequences (RT) and/or the time duration of the set of image display sequences (ST). Vice versa, when the AM ChLCD 100 is required to drive the cholesteric liquid crystals with a shorter driving time, the processor 41 then accordingly decreases the time duration of the set of image reset sequences (RT) and/or the time duration of the set of image display sequences (ST).

In another embodiment, the memory 42 stores a device characteristic information, the device characteristic information includes a relationship data that characterizes a driving voltage required for driving different materials of the cholesteric liquid crystals in the AM ChLCD 100 with various driving times. The different materials of the cholesteric liquid crystals in the AM ChLCD 100 characteristically entail different viscosities, different fluidities, different molecular distances, and different molecular arrangements of the cholesteric liquid crystals. For example, under same driving times, the higher the viscosity of the cholesteric liquid crystals in the AM ChLCD 100, the greater driving voltages the AM ChLCD 100 needs to drive the cholesteric liquid crystals, so as to adequately twist and adjust the cholesteric liquid crystals into a certain arrangement.

As the processor 41 configures the time duration of the set of image reset sequences (RT) and/or the time duration of the set of image display sequences (ST) according to the chronological sequences of the dynamic image parameter data, the vertical synchronization signal (Vsync), and the data enable signal (DE), the processor 41 configures the voltage value corresponding to each of the pixels when the AM ChLCD is displaying each of the images of the dynamic image. As such, as the dynamic image parameter data is adjusted, the timing controller 10 is able to generate and output the voltage control command (Iv) and the image display command (Id) according to the vertical synchronization signal (Vsync), the data enable signal (DE), and the dynamic image parameter data. The power supply module 20 generates adequate driving voltages for the AM ChLCD 100 according to the voltage control command (Iv), and the timing controller 10 supplies the said adequate driving voltages into each of the display units 111 through controlling the data driver component 130.

For example, according to the characterization of the material of the cholesteric liquid crystals in the AM ChLCD 100, and according to the set of image reset sequences (RT) and/or the set of image display sequences (ST) that is being executed, when the AM ChLCD 100 is required to drive the cholesteric liquid crystals with greater voltages, the processor 41 then accordingly increases the voltage values of the driving voltages outputted by the power supply 20 through adjusting the dynamic image parameter data according to the device characteristic information. Vice versa, when the AM ChLCD 100 is required to drive the cholesteric liquid crystals with less voltages, the processor 41 then accordingly decreases the voltage values of the driving voltages outputted by the power supply 20 through adjusting the dynamic image parameter data according to the device characteristic information.

By taking the device characteristic information of the AM ChLCD 100 into account, the driver system 1 of the present invention is able to adequately adjust how the AM ChLCD 100 is being driven, thus ensuring more precise control over the AM ChLCD 100, ensuring that no more than necessary amount of electric power is wasted, and ensuring various needs for driving the AM ChLCD 100 are satisfied.

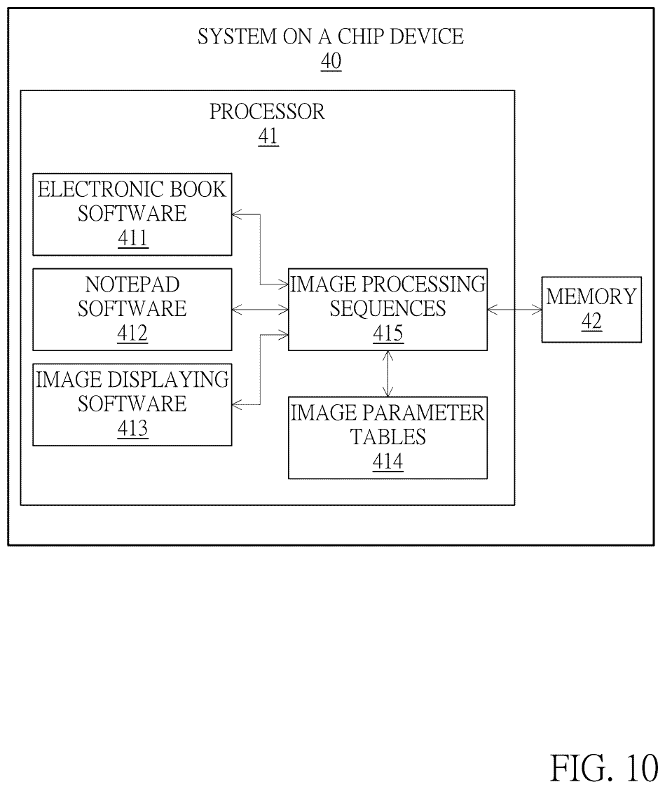

With reference to FIG. 10, in an embodiment, the processor 41 includes an electronic book software 411, a notepad software 412, an image displaying software 413, a plurality of image parameter tables 414, and a set of image processing sequences 415. The processor 41 is able to receive the dynamic image data of an electronic book from the electronic book software 411, the dynamic image data of a note from the notepad software 412, or the dynamic image data of a file from the image displaying software 413. Each of the image parameter tables 414 corresponds to a different image or video file type, and each of the image parameter tables 414 includes voltage parameters for displaying an image under different brightness and colorization conditions corresponding to the different image or video file types. The set of image processing sequences 415 is connected to the electronic book software 411, the notepad software 412, and the image displaying software 413, thus the set of image processing sequences 415 is able to receive the dynamic image data from the electronic book software 411, the notepad software 412, and/or the image displaying software 413. According to the image or video file type corresponding to the dynamic image data, the processor 41 image processes the dynamic image data with the set of image processing sequences 415 according to one of the image parameter tables 414, and thus the processor 41 generates the dynamic image parameter data corresponding to the dynamic image data. In an embodiment, the processor 41 operates with a Linux operating system and/or an Android operating system.

In an embodiment, the electronic book software 411, the notepad software 412, and the image displaying software 413 are able to receive an image control signal C, wherein the image control signal C is generated according to how a user of the present invention uses the AM ChLCD 100. For example, when the user wishes to read the electronic book stored in the electronic book software 411, the user uses the AM ChLCD 100, causing the AM ChLCD 100 to generate the image control signal C. The AM ChLCD 100 then outputs the dynamic image data corresponding to the electronic book specified by the image control signal C and subsequently displays a dynamic image of the electronic book.

In an embodiment, the processor 41 is able to receive a user configuration data through executing the electronic book software 411, the notepad software 412, and/or the image displaying software 413. The user configuration data is inputted by the user into the AM ChLCD 100. The user configuration data includes a displaying contrast parameter, a displaying enhancement parameter, a displaying brightness parameter, and a displaying colorization parameter for the current display that is being displayed by the AM ChLCD 100 through the electronic book software 411, the notepad software 412, and/or the image displaying software 413. The memory 42 may also store a display characteristic information. The display characteristic information characterizes a relationship between various displaying parameters, various driving voltages, the time duration of the set of image reset sequences (RT), and/or the time duration of the set of image display sequences (ST). The display characteristic information thus includes a relationship data that characterizes a driving voltage required for driving the AM ChLCD 100 under the various displaying parameters with various driving times.

On one hand, the processor 41 is able to adjust the chronological sequences of the dynamic image parameter data, the vertical synchronization signal (Vsync), and the data enable signal (DE) according to the user configuration data and the display characteristic information, thus further adjusting the time duration of the set of image reset sequences (RT) and/or the time duration of the set of image display sequences (ST), such as adjusting the number of frames included in the set of image reset sequences (RT) and/or in the time duration of the set of image display sequences (ST), for satisfying a display condition set forth by the user upon the current display of the AM ChLCD 100. For example, when the displaying contrast parameter is increased according to the user configuration data, under the same driving voltage, a longer driving time is required to satisfy the displaying contrast parameter as according to the display characteristic information. Therefore, the processor 41 would increase the time duration of the set of image reset sequences (RT) and/or the time duration of the set of image display sequences (ST). Vice versa, when the displaying contrast parameter is decreased according to the user configuration data, less driving time and less driving voltage are required to satisfy the displaying contrast parameter as according to the display characteristic information. Therefore, the processor 41 would decrease the time duration of the set of image reset sequences (RT) and/or the time duration of the set of image display sequences (ST).

On the other hand, the processor 41 is also able to adjust the voltage parameter of each of the pixels in each of the images in the dynamic image parameter data according to the user configuration data and the display characteristic information for the chronological sequences of the dynamic image parameter data, the vertical synchronization signal (Vsync), and the data enable signal (DE) under the set of image reset sequences (RT) and/or the time duration of the set of image display sequences (ST). This allows the timing controller 10 to output the voltage control command (Iv) and the image display command (Id) according to the vertical synchronization signal (Vsync), the data enable signal (DE), and the dynamic image parameter data, thus allowing the power supply module 20 to generate adequate driving voltages for the AM ChLCD 100 according to the voltage control command (Iv), and allowing the timing controller 10 to supply the said adequate driving voltages into each of the display units 111 through controlling the data driver component 130. For example, when the displaying contrast parameter is increased according to the user configuration data, under the set of image reset sequences (RT) and/or the time duration of the set of image display sequences (ST), greater voltage values are required for driving the AM ChLCD 100 in order to satisfy the displaying contrast parameter as according to the display characteristic information. Therefore, the processor 41 would increase the driving voltages outputted by the power supply module 20 according to the display characteristic information. Vice versa, when the displaying contrast parameter is decreased according to the user configuration data, under the set of image reset sequences (RT) and/or the time duration of the set of image display sequences (ST), less voltage values are required for driving the AM ChLCD 100 in order to satisfy the displaying contrast parameter as according to the display characteristic information. Therefore, the processor 41 would decrease the driving voltages outputted by the power supply module 20 according to the display characteristic information.

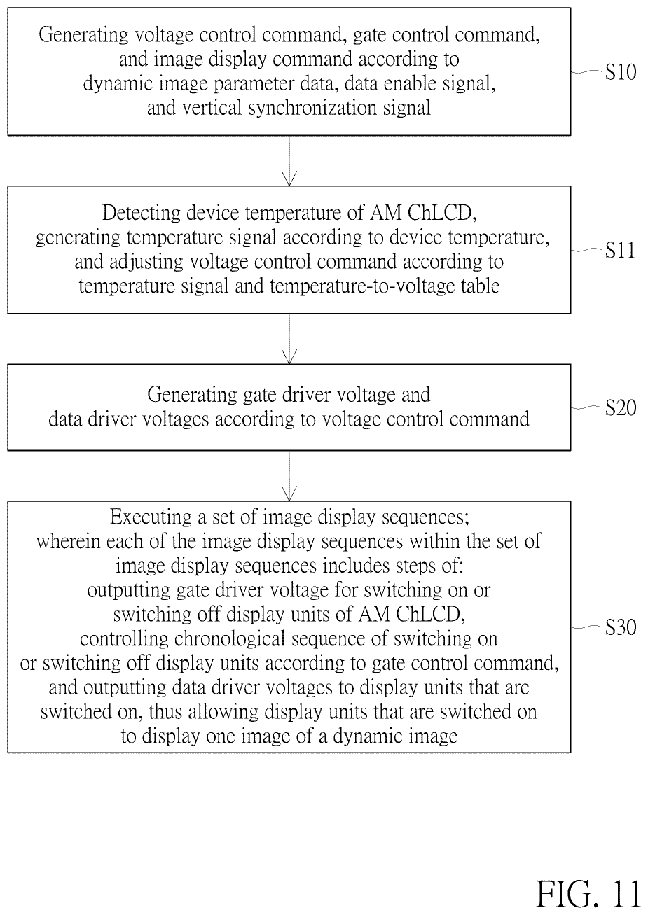

With reference to FIG. 11, a dynamic image displaying method of an AM ChLCD of the present invention is utilized for controlling the AM ChLCD 100, and the dynamic image displaying method of the present invention is executed by the driver system 1 of the AM ChLCD 100. The dynamic image displaying method of the present invention includes the following steps:
step S10: generating a voltage control command (Iv), a gate control command (Ig), and an image display command (Id) according to a dynamic image parameter data, a data enable signal (DE), and a vertical synchronization signal (Vsync); wherein the dynamic image parameter data corresponds to a dynamic image that consists of a plurality of images;
step S20: generating a gate driver voltage (Vg) and a plurality of data driver voltages (Vd) according to the voltage control command (Iv); and
step S30: executing a set of image display sequences (ST); wherein each of the image display sequences (ST) within the set of image display sequences (ST) includes steps of: outputting the gate driver voltage (Vg) to the plurality of display units 111 of the AM ChLCD 100 for switching on or switching off a plurality of display units 111 of the AM ChLCD 100, controlling a chronological sequence of switching on or switching off the plurality of display units 111 according to the gate control command (Ig), and outputting the plurality of data driver voltages (Vd) to the plurality of display units 111 that are switched on, thus allowing the plurality of display units 111 that are switched on to display one of the images of the dynamic image.

In step S30, within any two consecutive image display sequences (ST) within the set of image display sequences (ST), an averaged voltage magnitude of the plurality of data driver voltages (Vd) received by the plurality of display units 111 that are switched on within one of the two consecutive image display sequences (ST) equals an averaged voltage magnitude of the plurality of data driver voltages (Vd) received by the plurality of display units 111 that are switched on within the other one of the two consecutive image display sequences (ST). Moreover, within any two consecutive image display sequences (ST) within the set of image display sequences (ST), a voltage polarity of the averaged voltage magnitude of the plurality of data driver voltages (Vd) received by the plurality of display units 111 that are switched on within one of the image display sequences (ST) is opposite of a voltage polarity of the averaged voltage magnitude of the plurality of data driver voltages (Vd) received by the plurality of display units 111 that are switched on within the other one of the image display sequences (ST). As a result, within any two consecutive image display sequences (ST), a total averaged voltage of the plurality of data driver voltages (Vd) received by the plurality of display units 111 that are switched on is zero volt.

In an embodiment, two consecutive image display sequences (ST) within the set of image display sequences (ST) includes at least one positive polarity display period (Sp) and at least one negative polarity display period (Sn). Within the at least one positive polarity display period (Sp), the data driver component 130 outputs the plurality of data driver voltages (Vd) with positive polarity to the plurality of display units 111. Within the at least one negative polarity display period (Sn), the data driver component 130 outputs the plurality of data driver voltages (Vd) with negative polarity to the plurality of display units 111. Within two consecutive image display sequences (ST), an averaged voltage magnitude of the plurality of data driver voltages (Vd) within the at least one positive polarity display period (Sp) equals an averaged voltage magnitude of the plurality of data driver voltages (Vd) within the at least one negative polarity display period (Sn). Moreover, a number of the at least one positive polarity display period (Sp) equals a number of the at least one negative polarity display period (Sn), and a total duration of each positive polarity display period (Sp) equals a total duration of each negative polarity display period (Sn). Since the data driver voltages (Vd) with positive polarity and the data driver voltages (Vd) with negative polarity are equal both in time durations and in averaged voltage magnitudes, within any two consecutive image display sequences (ST), a total voltage average of adding the data driver voltages (Vd) with positive polarity and the data driver voltages (Vd) with negative polarity equals zero volt.

In an embodiment, in step S30, each image display sequence (ST) includes at least one positive polarity display period (Sp) and at least one negative polarity display period (Sn). Within the at least one positive polarity display period (Sp), the plurality of data driver voltages (Vd) with positive polarity are outputted to the plurality of display units 111. Within the at least one negative polarity display period (Sn), the plurality of data driver voltages (Vd) with negative polarity are outputted to the plurality of display units 111. An averaged voltage magnitude of the plurality of data driver voltages (Vd) within the at least one positive polarity display period (Sp) equals an averaged voltage magnitude of the plurality of data driver voltages (Vd) within the at least one negative polarity display period (Sn). A total duration of each positive polarity display period (Sp) equals a total duration of each negative polarity display period (Sn). Within each image display sequence (ST), a total voltage average of adding the data driver voltages (Vd) with positive polarity and the data driver voltages (Vd) with negative polarity equals zero volt.

In an embodiment, step S10 also includes: generating a common electrode voltage (Vcom) according to the voltage control command (Iv), and step S30 also includes: alternating an execution of a set of image reset sequences (RT) with the execution of the set of image display sequences (ST), so as to execute one of the image reset sequences (RT) before executing each of the image display sequences (ST). Each of the image reset sequences (RT) within the set of image reset sequences (RT) includes steps of: outputting the gate driver voltage (Vg) to the plurality of display units 111 of the AM ChLCD 100 for switching on or switching off a plurality of display units 111 of the AM ChLCD 100, controlling the chronological sequence of switching on or switching off the plurality of display units 111 according to the gate control command (Ig), and outputting the common electrode voltage (Vcom) to the plurality of display units 111 that are switched on, thus allowing the plurality of display units 111 that are switched on to reset the current display.

Furthermore, each image reset sequence (RT) includes at least one positive polarity reset period (Rp) and at least one negative polarity reset period (Rn). Within the at least one positive polarity reset period (Rp), the common electrode voltage (Vcom) with negative polarity is outputted to the plurality of display units 111 that are switched on. Within the at least one negative polarity reset period (Rn), the common electrode voltage (Vcom) with positive polarity is outputted to the plurality of display units 111 that are switched on. A voltage magnitude of the common electrode voltage (Vcom) with negative polarity equals a voltage magnitude of the common electrode voltage (Vcom) with positive polarity. A total duration of the at least one positive polarity reset period (Rp) equals a total duration of the at least one negative polarity reset period (Rn). In each image reset sequence (RT), a total voltage average of adding the common electrode voltage (Vcom) with positive polarity and the common electrode voltage (Vcom) with negative polarity equals zero volt.

Furthermore, in an embodiment, after step S10, the method further includes the following step:
step S11: detecting a device temperature of the AM ChLCD 100, generating a temperature signal T according to the device temperature, and adjusting the voltage control command (Iv) according to the temperature signal T and a temperature-to-voltage table.

In an embodiment, step S10 further includes steps of:
adjusting chronological sequences of the dynamic image parameter data, the vertical synchronization signal (Vsync), and the data enable signal (DE) according to a device characteristic information; and
configuring the time duration of the set of image reset sequences (RT) and/or the time duration of the set of image display sequences (ST) according to the chronological sequences of the dynamic image parameter data, of the vertical synchronization signal (Vsync), and of the data enable signal (DE).

In an embodiment, step S10 further includes a step of: adjusting a voltage parameter of each pixel in the dynamic image parameter data according to the device characteristic information. Step S20 further includes a step of: generating the voltage control command (Iv) and an image display command (Id) according to the vertical synchronization signal (Vsync), the data enable signal (DE), and the dynamic image parameter data. Step S30 further includes a step of: generating the gate driver voltage (Vg), the plurality of data driver voltages (Vd), and the common electrode voltage (Vcom) according to the voltage control command (Iv) for satisfying the displaying characteristics of the AM ChLCD 100.

In an embodiment, step S10 includes steps of:
receiving a user configuration data inputted by the user;
adjusting the chronological sequences of the dynamic image parameter data, of the vertical synchronization signal (Vsync), and of the data enable signal (DE) according to a display characteristic information of the AM ChLCD 100 and the user configuration data; and
configuring the time duration of the set of image reset sequences (RT) and/or the time duration of the set of image display sequences (ST) according to the chronological sequences of the dynamic image parameter data, of the vertical synchronization signal (Vsync), and of the data enable signal (DE).

In an embodiment, step S10 includes steps of: receiving a user configuration data inputted by the user; and adjusting a voltage parameter of each pixel in the dynamic image parameter data according to a display characteristic information of the AM ChLCD 100 and the user configuration data. Step S20 further includes a step of: generating the voltage control command (Iv) and an image display command (Id) according to the vertical synchronization signal (Vsync), the data enable signal (DE), and the dynamic image parameter data. Step S30 further includes a step of: generating the gate driver voltage (Vg), the plurality of data driver voltages (Vd), and the common electrode voltage (Vcom) according to the voltage control command (Iv).

Overall, the driver system 1 of the AM ChLCD 100 and the dynamic image displaying method thereof, utilize the voltage control command (Iv) outputted by the timing controller 10 to control the power supply module 20 to supply the gate driver voltage (Vg), the plurality of data driver voltages (Vd), and the common electrode voltage (Vcom) to the AM ChLCD 100, and also utilize the gate control command (Ig) and the image display command (Id) outputted by the timing controller 10 to control the AM ChLCD 100 for displaying one of the images of a dynamic image. Through consecutively displaying the various images, the dynamic image is displayed.

As the processor 41 before the timing controller 10 already image processes the dynamic image data with the set of image processing sequences, the timing controller 10 of the present invention does not need to image process the dynamic image data. Instead of requiring a large memory to store the dynamic image data for a conventional driver of a conventional passive matrix cholesteric liquid crystal display (PM ChLCD) to image process, the timing controller 10 of the present invention only needs to generate corresponding commands according to the dynamic image parameter data that is outputted by the processor 41, and thus the timing controller 10 of the present invention requires significantly less memory. As a result, by requiring much less memory, the present invention is able to free up more physical space required for implementing memory, decrease cost for implementing memory, and allow the driver system 1 of the AM ChLCD 100 to be more miniaturized overall.

Furthermore, since the AM ChLCD 100 utilizes active electronic components instead of passive ones, unlike the conventional PM ChLCD, less time is required for the AM ChLCD 100 to update each frame. Under a same driving voltage, the AM ChLCD 100 is able to display with higher contrast than the conventional PM ChLCD does. Moreover, the timing controller 10 of the present invention does not need to iteratively drive the AM ChLCD 100 with the same data driver voltage (Vd) for raising the contrast in a current display. This allows the AM ChLCD 100 to update the current display with less amount of time, and allows the AM ChLCD 100 to have a higher frame rate for displaying and updating each of the images of the dynamic image, thus allowing the user to view and read the images of the dynamic image with a better experience.

Furthermore, within the set of image reset sequences (RT), the present invention utilizes voltages of same voltage magnitude but opposite polarities, or more specifically, the common electrode voltage (Vcom) with positive polarity and the common electrode voltage (Vcom) with negative polarity to drive the AM ChLCD 100. Similarly, within the set of image display sequences (ST), the present invention also utilizes voltages of same voltage magnitude but opposite polarities, or more specifically, the plurality of data driver voltages (Vd) with positive polarity and the plurality of data driver voltages (Vd) with negative polarity to drive the AM ChLCD 100. As a result, the present invention is able to prevent the cholesteric liquid crystals of the AM ChLCD 100 from being permanently polarized, and thus preventing image sticking and uneven brightness in the current display, and increasing a life expectancy of the AM ChLCD 100.

The present invention adjusts the time duration of the set of image reset sequences (RT) and/or the time duration of the set of image display sequences (ST) according to the device characteristic information of the AM ChLCD 100 or the user configuration data. The present invention also accordingly adjusts the gate driver voltage (Vg), the plurality of data driver voltages (Vd), and the common electrode voltage (Vcom) outputted to the AM ChLCD 100 for satisfying a device characteristic of the AM ChLCD 100, or for satisfying a certain display characteristic specified by the user. As a result, the present invention is able to more precisely drive the AM ChLCD 100 to better display the dynamic image.

What is claimed is:

1. A driver system of an active matrix cholesteric liquid crystal display (AM ChLCD), utilized for controlling the AM ChLCD, wherein the AM ChLCD comprises a gate driver component, a data driver component, and a plurality of display units; wherein the plurality of display units are electrically connected to the gate driver component and the data driver component; wherein the driver system of the AM ChLCD comprises:
a timing controller, connected to the AM ChLCD; wherein according to a dynamic image parameter data, a data enable signal, and a vertical synchronization signal, the timing controller generates a voltage control command, a gate control command, and an image display command, outputs the gate control command to the gate driver component, outputs the image display command to the data driver component, and controls the AM ChLCD to execute a set of image display sequences; wherein the dynamic image parameter data corresponds to a dynamic image that consists of a plurality of images, and each of the image display sequences within the set of image display sequences is executed to display one of the images of the dynamic image;
a power supply module, connected to the timing controller and the AM ChLCD; wherein according to the voltage control command, the power supply module generates a gate driver voltage and a plurality of data driver voltages, outputs the gate driver voltage to the gate driver component, and outputs the plurality of data driver voltages to the data driver component;
wherein in the set of image display sequences: the timing controller controls a chronological sequence of commanding the gate driver component to switch on or switch off the plurality of display units according to the gate control command; the gate driver component controls the plurality of display units to switch on or switch off according to the gate driver voltage; according to the image display command, the timing controller controls the data driver component to output the plurality of data driver voltages to the plurality of display units that are switched on;
wherein within any two consecutive image display sequences within the set of image display sequences, an averaged voltage magnitude of the plurality of data driver voltages outputted by the data driver component within one of the two consecutive image display sequences equals an averaged voltage magnitude of the plurality of data driver voltages outputted by the data driver component within the other one of the two consecutive image display sequences;
wherein within any two consecutive image display sequences within the set of image display sequences, an overall averaged voltage magnitude of the plurality of data driver voltages outputted by the data driver component is zero.

2. The driver system as claimed in claim 1, wherein any two consecutive image display sequences within the set of image display sequences comprise at least one positive polarity display period and at least one negative polarity display period; within the at least one positive polarity display period, the data driver component outputs the plurality of data driver voltages with positive polarity; within the at least one negative polarity display period, the data driver component outputs the plurality of data driver voltages with negative polarity;
wherein an averaged voltage magnitude of the plurality of data driver voltages within the at least one positive polarity display period equals an averaged voltage magnitude of the plurality of data driver voltages within the at least one negative polarity display period;
wherein within any two consecutive image display sequences within the set of image display sequences, a total voltage average of adding the data driver voltages with positive polarity plus the data driver voltages with negative polarity equals zero volt.

3. The driver system as claimed in claim 1, wherein each of the set of image display sequences comprises at least one positive polarity display period and at least one negative polarity display period; within the at least one positive polarity display period, the data driver component outputs the plurality of data driver voltages with positive polarity; within the at least one negative polarity display period, the data driver component outputs the plurality of data driver voltages with negative polarity;
wherein within any two consecutive image display sequences within the set of image display sequences, a total duration of the at least one positive polarity display period equals a total duration of the at least one negative polarity display period, and an averaged voltage magnitude of the plurality of data driver voltages within the at least one positive polarity display period equals an averaged voltage magnitude of the plurality of data driver voltages within the at least one negative polarity display period.

4. The driver system as claimed in claim 1, wherein each of the set of image display sequences comprises at least one positive polarity display period and at least one negative polarity display period; within the at least one positive polarity display period, the data driver component outputs the plurality of data driver voltages with positive polarity; within the at least one negative polarity display period, the data driver component outputs the plurality of data driver voltages with negative polarity;
wherein within each of the set of image display sequences, a total duration of the at least one positive polarity display period equals a total duration of the at least one negative polarity display period, and an averaged voltage magnitude of the plurality of data driver voltages within the at least one positive polarity display period equals an averaged voltage magnitude of the plurality of data driver voltages within the at least one negative polarity display period.

5. The driver system as claimed in claim 1, wherein the timing controller controls the AM ChLCD to execute a set of image reset sequences, and the power supply module generates a common electrode voltage according to the voltage control command;
wherein in each of the set of image reset sequences: the timing controller controls a chronological sequence of commanding the gate driver component to switch on or switch off the plurality of display units according to the gate control command; the gate driver component controls the plurality of display units to switch on or switch off according to the gate driver voltage; the timing controller controls the data driver component to output the common electrode voltage to the plurality of display units that are switched on;
wherein each of the set of image reset sequences comprises at least one positive polarity reset period and at least one negative polarity reset period; within the at least one positive polarity reset period, the plurality of display units that are switched on respectively receive the common electrode voltage with negative polarity, and within the at least one negative polarity reset period, the plurality of display units that are switched on respectively receive the common electrode voltage with positive polarity;
wherein a total duration of the at least one positive polarity reset period equals a total duration of the at least one negative polarity reset period;
wherein a voltage magnitude of the common electrode voltage with negative polarity in the at least one positive polarity reset period equals a voltage magnitude of the common electrode voltage with positive polarity in the at least one negative polarity reset period.

6. The driver system as claimed in claim 1, further comprising:
a temperature detection module, connected to the timing controller, mounted on the AM ChLCD for detecting a device temperature of the AM ChLCD, and generating a temperature signal according to the device temperature;
wherein the timing controller adjusts the voltage control command according to the temperature signal and a temperature-to-voltage table.

7. The driver system as claimed in claim 1, further comprising:
a system on a chip (SoC), connected to the AM ChLCD, and comprising:
a processor, image processing a dynamic image data, and generating the dynamic image parameter data, the vertical synchronization signal, and the data enable signal according to a voltage parameter of each pixel in each of the images comprised in the dynamic image parameter data;
a memory, connected to the processor, storing the dynamic image parameter data, the vertical synchronization signal, and the data enable signal.

8. The driver system as claimed in claim 7, wherein the processor adjusts chronological sequences of the dynamic image parameter data, the vertical synchronization signal, and the data enable signal according to a device characteristic information, and the processor configures a time duration of the set of image display sequences according to the chronological sequences of the dynamic image parameter data, the vertical synchronization signal, and the data enable signal; or
the processor adjusts the voltage parameter of each pixel in the dynamic image parameter data according to the device characteristic information;
wherein the device characteristic information comprises a relationship data that characterizes a driving voltage required for driving different materials of cholesteric liquid crystals in the AM ChLCD with various driving times.

9. The driver system as claimed in claim 7, wherein the processor comprises a plurality of image parameter tables and a set of image processing sequences, and each of the image parameter tables corresponds to a different image or video file type;
wherein the processor image processes the dynamic image data with the set of image processing sequences according to one of the image parameter tables, and thus the processor generates the dynamic image parameter data corresponding to the dynamic image data.

10. The driver system as claimed in claim 7, wherein the processor adjusts chronological sequences of the dynamic image parameter data, the vertical synchronization signal, and the data enable signal according to a display characteristic information and a user configuration data, and the processor configures a time duration of the set of image display sequences according to the chronological sequences of the dynamic image parameter data, the vertical synchronization signal, and the data enable signal; or
the processor adjusts the voltage parameter of each pixel in the dynamic image parameter data according to the display characteristic information and the user configuration data;
wherein the user configuration data comprises various displaying parameters for the AM ChLCD, and the display characteristic information comprises a relationship data that characterizes a driving voltage required for driving the AM ChLCD under the various displaying parameters with various driving times.

11. The driver system as claimed in claim 7, wherein the processor generates the vertical synchronization signal that defines a specific time at which the AM ChLCD changes frames when displaying the dynamic image;
wherein within a triggered period of the vertical synchronization signal, a current display of the AM ChLCD remains constant when displaying the dynamic image, and the data enable signal is triggered for a plurality of times.

12. A dynamic image displaying method of an active matrix cholesteric liquid crystal display (AM ChLCD), executed by a driver system for controlling the AM ChLCD, comprising steps as follows:
generating a voltage control command, a gate control command, and an image display command according to a dynamic image parameter data, a data enable signal, and a vertical synchronization signal; wherein the dynamic image parameter data corresponds to a dynamic image that consists of a plurality of images;
generating a gate driver voltage and a plurality of data driver voltages according to the voltage control command; and
executing a set of image display sequences; wherein each of the image display sequences within the set of image display sequences comprises steps of: outputting the gate driver voltage for switching on or switching off a plurality of display units of the AM ChLCD, controlling a chronological sequence of switching on or switching off the plurality of display units according to the gate control command, and outputting the plurality of data driver voltages to the plurality of display units that are switched on; wherein each of the image display sequences within the set of image display sequences controls the AM ChLCD to display one of the images of the dynamic image;
wherein within any two consecutive image display sequences within the set of image display sequences, an averaged voltage magnitude of the plurality of data driver voltages outputted by a data driver component within one of the two consecutive image display sequences equals an averaged voltage magnitude of the plurality of data driver voltages outputted by the data driver component within the other one of the two consecutive image display sequences;
wherein within any two consecutive image display sequences within the set of image display sequences, an overall averaged voltage magnitude of the plurality of data driver voltages outputted by the data driver component to the plurality of display units is zero.

13. The dynamic image displaying method as claimed in claim 12, wherein any two consecutive image display sequences within the set of image display sequences comprise at least one positive polarity display period and at least one negative polarity display period; within the at least one positive polarity display period, the data driver component outputs the plurality of data driver voltages with positive polarity; within the at least one negative polarity display period, the data driver component outputs the plurality of data driver voltages with negative polarity;
wherein an averaged voltage magnitude of the plurality of data driver voltages within the at least one positive polarity display period equals an averaged voltage magnitude of the plurality of data driver voltages within the at least one negative polarity display period;
wherein within any two consecutive image display sequences, a total voltage average of adding the data driver voltages with positive polarity plus the data driver voltages with negative polarity equals zero volt.

14. The dynamic image displaying method as claimed in claim 12, wherein each of the set of image display sequences comprises at least one positive polarity display period and at least one negative polarity display period; within the at least one positive polarity display period, the data driver component outputs the plurality of data driver voltages with positive polarity; within the at least one negative polarity display period, the data driver component outputs the plurality of data driver voltages with negative polarity;
wherein within any two consecutive image display sequences within the set of image display sequences, a total duration of the at least one positive polarity display period equals a total duration of the at least one negative polarity display period, and an averaged voltage magnitude of the plurality of data driver voltages within the at least one positive polarity display period equals an averaged voltage magnitude of the plurality of data driver voltages within the at least one negative polarity display period.

15. The dynamic image displaying method as claimed in claim 12, wherein each of the set of image display sequences comprises at least one positive polarity display period and at least one negative polarity display period; within the at least one positive polarity display period, the data driver component outputs the plurality of data driver voltages with positive polarity; within the at least one negative polarity display period, the data driver component outputs the plurality of data driver voltages with negative polarity;
wherein within each of the set of image display sequences, a total duration of the at least one positive polarity display period equals a total duration of the at least one negative polarity display period, and an averaged voltage magnitude of the plurality of data driver voltages within the at least one positive polarity display period equals an averaged voltage magnitude of the plurality of data driver voltages within the at least one negative polarity display period.

16. The dynamic image displaying method as claimed in claim 12, further comprising steps as follows:
generating a common electrode voltage according to the voltage control command;
alternating an execution of a set of image reset sequences with the execution of the set of image display sequences; wherein the set of image reset sequences comprises steps of: outputting the gate driver voltage to the plurality of display units for switching on or switching off the plurality of display units, controlling a chronological sequence of switching on or switching off the plurality of display units according to the gate control command, and outputting the common electrode voltage to the plurality of display units that are switched on;
wherein each of the set of image reset sequences comprises at least one positive polarity reset period and at least one negative polarity reset period;
within the at least one positive polarity reset period, the plurality of display units that are switched on respectively receive the common electrode voltage with negative polarity, and within the at least one negative polarity reset period, the plurality of display units that are switched on respectively receive the common electrode voltage with positive polarity;
wherein a total duration of the at least one positive polarity reset period equals a total duration of the at least one negative polarity reset period;
wherein a voltage magnitude of the common electrode voltage with negative polarity in the at least one positive polarity reset period equals a voltage magnitude of the common electrode voltage with positive polarity in the at least one negative polarity reset period.

17. The dynamic image displaying method as claimed in claim 12, wherein after the voltage control command is generated, further comprising the following steps:
detecting a device temperature of the AM ChLCD, generating a temperature signal according to the device temperature, and adjusting the voltage control command according to the temperature signal and a temperature-to-voltage table.

18. The dynamic image displaying method as claimed in claim 12, further comprising the following steps:
adjusting chronological sequences of the dynamic image parameter data, the vertical synchronization signal, and the data enable signal according to a device characteristic information; and
configuring a time duration of the set of image display sequences according to the chronological sequences of the dynamic image parameter data, the vertical synchronization signal, and the data enable signal;
or
adjusting the voltage parameter of each pixel in each of the images comprised in the dynamic image parameter data according to the device characteristic information;
wherein the device characteristic information comprises a relationship data that characterizes a driving voltage required for driving different materials of cholesteric liquid crystals in the AM ChLCD with various driving times.

19. The dynamic image displaying method as claimed in claim 12, further comprising:
adjusting chronological sequences of the dynamic image parameter data, the vertical synchronization signal, and the data enable signal according to a display characteristic information and a user configuration data; and
configuring a time duration of the set of image display sequences according to the chronological sequences of the dynamic image parameter data, the vertical synchronization signal, and the data enable signal;
or
adjusting the voltage parameter of each pixel in each of the images comprised in the dynamic image parameter data according to the display characteristic information and the user configuration data;
wherein the user configuration data comprises various displaying parameters for the AM ChLCD, and the display characteristic information comprises a relationship data that characterizes a driving voltage required for driving the AM ChLCD under the various displaying parameters with various driving times.

20. The dynamic image displaying method as claimed in claim 12, wherein the vertical synchronization signal is utilized for defining a specific time at which each frame of the dynamic image changes;
wherein within a triggered period of the vertical synchronization signal, a current display of the dynamic image remains constant, and the data enable signal is triggered for a plurality of times.
